(19) United States
(12) Patent Application Publication
(10) Pub. No.: US 2014/0149669 A1
(43) Pub. Date: May 29, 2014

(54) CACHE MEMORY AND METHODS FOR MANAGING DATA OF AN APPLICATION PROCESSOR INCLUDING THE CACHE MEMORY

(71) Applicants: Sungyeum KIM, Goyang-si (KR); Hyeokman KWON, Suwon-si (KR); Youngjun KWON, Seongnam-si (KR); Kiyoung CHOI, Seoul (KR); Junwhan AHN, Seoul (KR)

(72) Inventors: Sungyeum KIM, Goyang-si (KR); Hyeokman KWON, Suwon-si (KR); Youngjun KWON, Seongnam-si (KR); Kiyoung CHOI, Seoul (KR); Junwhan AHN, Seoul (KR)

(21) Appl. No.: 14/086,188

(22) Filed: Nov. 21, 2013

(30) Foreign Application Priority Data
Nov. 23, 2012 (KR) 10-2012-0133553

(51) Int. Cl. G06F 12/08

(52) U.S. Cl. CPC G06F 12/0806
USPC 711/119

(57) ABSTRACT

In one example embodiment of the inventive concepts, a cache memory system includes a main cache memory including a nonvolatile random access memory, the main cache memory configured to exchange data with an external device and store the exchange data, each exchanged data includes less significant bit (LSB) data and more significant bit (MSB) data. The cache memory system further includes a sub-cache memory including a random access memory, the sub-cache memory configured to store LSB data of at least a portion of data stored at the main cache memory, wherein the main cache memory and the sub-cache memory are formed of a single-level cache memory.

### CROSS-REFERENCE TO RELATED APPLICATIONS

A claim for priority under 35 U.S.C. §119 is made to Korean Patent Application No. 10-2012-0133553 filed Nov. 23, 2012, in the Korean Intellectual Property Office, the entire contents of which are hereby incorporated by reference.

### BACKGROUND

The inventive concepts described herein relate to semiconductor devices, and more particularly, relate to a cache memory and/or data managing methods of an application processor including the cache memory.

In recent years, the use of portable devices such as smart phones, smart pads, notebook computers, and so on have increased rapidly. Developments of semiconductors and communications technologies have increased throughputs of portable devices. Such increases in throughputs of portable devices have led such devices to be named a “smart device”.

Smart devices enable a user to install applications freely and to produce and process information using the installed applications. As more and more applications and content for such smart devices are developed, improvements to operability of the smart device are desired.

Among methods of improving operability of such devices, one method may be directed to improving the performance of a cache memory, which is used by an application processor of a smart device, so as to reduce power consumption of the application processor.

### SUMMARY

In one example embodiment of the inventive concepts, a cache memory system includes a main cache memory including a nonvolatile random access memory. The main cache memory is configured to exchange data with an external device and store the exchange data, each exchanged data includes less significant bit (LSB) data and more significant bit (MSB) data. The cache memory system further includes a sub-cache memory including a random access memory. The sub-cache memory is configured to store LSB data of at least a portion of data stored at the main cache memory, wherein the main cache memory and the sub-cache memory are formed of a single-level cache memory.

In yet another example embodiment, each of the main cache memory and the sub-cache memory includes a plurality of lines, an invalid line being one of the plurality of lines that does not store data. When an invalid line, which does not store valid data, exists at the sub-cache memory and new data is received from the external device, the main cache memory is further configured to store MSB data of the received data at an MSB area of a selected invalid line of the main cache memory and the sub-cache memory is further configured to store LSB data of the received data at the invalid line of the sub-cache memory.

In yet another example embodiment, each of the main cache memory and the sub-cache memory includes a plurality of lines, an invalid line being one of the plurality of lines that does not store data. When an invalid line, which does not store valid data, does not exist at the sub-cache memory and new data is received from the external device, the sub-cache memory is further configured to write LSB data stored at a selected line of the sub-cache memory, to an LSB area of a corresponding line of the main cache memory, invalidate the written LSB data at the selected line of the sub-cache memory and store LSB data of the received data at selected line of the sub-cache memory. The main cache memory is further configured to store MSB data of the received data at an MSB area of a selected invalid line of the main cache memory.

In yet another example embodiment, if a difference exists between update data of an update data received from the external device and LSB data stored at the sub-cache memory, the sub-cache memory is further configured to update the LSB data of the data stored at the sub-cache memory with the LSB data of the update data.

In yet another example embodiment, if a difference exists between LSB data of an update data received from the external device and LSB data of data stored at the main cache memory, the main cache memory is further configured to update the LSB data of the original data stored at the main cache memory with the LSB data of the update data.

In yet another example embodiment, when MSB data of selected data is stored at the main cache memory, LSB data of the selected data is stored at the sub-cache memory, and the selected data is to be read by the external device, the main cache memory is further configured to provide the MSB data stored at the main cache memory to the external device and the sub-cache memory is further configured to provide LSB data stored at the sub-cache memory to the external device.

In yet another example embodiment, when MSB data of selected data is stored at the main cache memory, LSB data of the selected data is stored at the main cache memory, and the selected data is to be read by the external device, the main cache memory is further configured to provide MSB data and LSB data stored at the main cache memory to the external device.

In yet another example embodiment, the main cache memory is a magnetic random access memory.

In yet another example embodiment, the sub-cache memory is a static random access memory.

In yet another example embodiment, the sub-cache memory consumes less power for a write operation compared to a write operation carried out by the main cache memory.

In yet another example embodiment, the sub-cache memory operates based on the main cache memory.

In yet another example embodiment, the main cache memory includes an address buffer configured to store a line index and a tag received from the external device. The main cache memory further includes a plurality of data arrays, each data array including a plurality of lines, each line being configured to store LSB data and MSB data associated with one of the received data. The main cache memory further includes a tag array configured to store tags associated with data stored at the plurality of data arrays and a first intermediate circuit configured to access the tag array and determine whether a first hit is generated, based on the line index and the tag stored at the address buffer. The main cache memory further includes a first input/output circuit configured to access the plurality of data arrays according to the line index and the determination of the generated first hit by the first intermediate circuit.

In yet another example embodiment, the sub-cache memory includes an LSB address buffer configured to receive the line index from the address buffer, to receive information on a location of the plurality of data arrays for which the first intermediate circuit has determined that the first hit is generated, and output an LSB line index and an LSB tag based on the input line index and the received information. The sub-cache memory further includes a plurality of LSB data arrays, each LSB data array including a plurality of sub-lines, each sub-line being configured to store LSB data; an LSB tag array configured to store LSB tags associated with LSB data stored at the plurality of LSB data arrays. The sub-cache memory further includes a second intermediate circuit configured to access the LSB tag array and determine whether a second hit is generated, based on the LSB line index and the LSB tag output from the LSB address buffer. The sub-cache memory further includes a second input/output circuit configured to access the plurality of LSB data arrays according to the LSB line index and the determination of the generated second hit by the second intermediate circuit.

In one example embodiment of the inventive concepts, a data managing method of an application processor, which includes a main cache memory and a sub-cache memory, includes fetching MSB data and LSB data. The method further includes managing the fetched MSB data using an MSB area of the main cache memory and the fetched LSB data using at least one of the sub-cache memory and an LSB area of the main cache memory, wherein the MSB data and the LSB data form a data line being a data transfer unit.

In yet another example embodiment, the managing includes receiving the LSB data and the MSB data; and storing the received MSB data at the MSB area of the main cache memory and the received LSB data at an invalid line of the sub-cache memory when an invalid line exists at the sub-cache memory, the invalid line being a line that does not store data.

In yet another example embodiment, when an invalid line does not exist at the sub-cache memory, the method further includes writing to the main cache memory, at least one additional LSB data previously stored at a given location of the sub-cache memory, and storing the received LSB data at the given location of the sub-cache memory.

In yet another example embodiment, the managing includes receiving updated data including updated LSB data and updated MSB data, reading data corresponding to the updated LSB data and the updated MSB data from at least one of the main cache memory and the sub-cache memory. The managing further includes comparing the read data and the updated LSB data and the updated MSB data and updating LSB data of the read data stored at the sub-cache memory when (1) the comparison result indicates that the LSB data of the read data and the updated LSB data are different from each other and (2) the updated LSB data of the read data is stored at the sub-cache memory. The managing further includes updating LSB data of the read data stored at the LSB area of the main cache memory when (1) the comparison result indicates that the LSB data of the read data and (2) the updated LSB data are different from each other and the LSB data of the read data is stored at the LSB area of the main cache memory. The method further includes updating MSB data of the read data stored at the MSB area of the main cache memory when the comparison result indicates that the MSB data of the read data and the updated MSB data of the received updated data are different from each other.

In yet another example embodiment, the managing includes receiving a data request; selecting data corresponding to the data request from the main cache memory and the sub-cache memory; and reading the selected data.

In yet another example embodiment, the managing includes decoding a tag of the main cache memory; accessing data of the main cache memory based on the decoded tag of the main cache memory; decoding a tag of the sub-cache memory while data of the main cache memory is accessed; and accessing data of the sub-cache memory, based on the decoded tag of the sub-cache memory.

In yet another example embodiment, the managing includes decoding a tag of the main cache memory; accessing data of the main cache memory when the tag of the main cache memory is decoded; decoding a tag of the sub-cache memory when the tag of the main cache memory is decoded; and accessing data of the sub-cache memory when the tag of the main cache memory is decoded.

In one example embodiment, an application processor is configured to exchange data with an external device and store a first portion of the exchanged data in a main cache memory of the application processor, the main cache memory including a nonvolatile random access memory. The application processor is further configured to store a second portion of the exchanged data in a sub-cache memory of the application processor, the sub-cache memory including a random access memory.

In yet another example embodiment, the application processor is configured to exchange the data by at least one of receiving the data from an external device to be stored in at least one of the main cache memory and the sub-cache memory of the application processor and providing the stored data to be read by the external device.

In yet another example embodiment, the first portion of the exchanged data includes more significant bit (MSB) data of the exchanged data and the second portion of the exchanged data includes less significant bit (LSB) data of the exchanged data.

In yet another example embodiment, upon receiving data from the external device, the application processor is configured to store the MSB data of the received data in the main cache memory.

In yet another example embodiment, upon receiving data from the external device, the application processor is configured to determine whether an empty location for storing the LSB data of the received data exists within the sub-cache memory and store the LSB data of the received data in the determined empty location of the sub-cache memory.

In yet another example embodiment, the application processor is further configured to, upon determining that no empty location for storing the LSB data of the received data exists within the sub-cache memory, write an LSB data of at least one additional data already stored in a given location of the sub-cache memory into an empty location of the main cache memory corresponding to a location of the main memory in which the MSB data of the at least one additional data is stored and store the LSB data of the received data in the given location of the sub-cache memory.

In yet another example embodiment, upon receiving updated data, the application processor is further configured to, determine whether LSB data of the updated data is different from the LSB data of the data already stored in one of the main cache memory and the sub-cache memory and replace the LSB data of the data already stored with the LSB data of the updated data, upon determining that the LSB data of the updated data is different from the LSB data of the data already stored.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 a block diagram schematically illustrating a computing system, according to an example embodiment of the inventive concepts;

FIG. 2 is a flow chart schematically illustrating a data managing method of an application processor of FIG. 1, according to an example embodiment;

FIGS. 3A and 3B are diagrams illustrating relations among a main memory, a main cache memory and a sub-cache memory of FIG. 1, according to an example embodiment;

FIG. 3C is a diagrams schematically illustrating a main cache memory and a sub-cache memory of FIG. 3A, according to an example embodiment;

FIG. 4 is a flow chart of a method for storing data at cache memories of FIG. 3C, according to an example embodiment;

FIGS. 5A to 5C are block diagrams schematically illustrating example embodiments where a storing method of FIG. 4 is executed at a cache structure of FIG. 3C;

FIG. 6 is a flow chart schematically illustrating a method of updating data of cache memories of FIG. 3C, according to an example embodiment;

FIGS. 7A to 7C are block diagrams schematically illustrating example embodiments where a storing method of FIG. 6 is executed at a cache structure of FIG. 3C;

FIG. 8 is a flow chart schematically illustrating a method where a read operation is executed at cache memories of FIG. 3C, according to an example embodiment;

FIGS. 9A to 9C are block diagrams schematically illustrating example embodiments where a read method of FIG. 8 is executed at a cache structure of FIG. 3;

FIGS. 10A and 10B are flow charts schematically illustrating example embodiments where data is written at a main cache memory 113 and a sub-cache memory 115 of FIGS. 1, 3A and 3B;

FIG. 100 is a flow chart schematically illustrating an embodiment where data is read from a main cache memory 113 and a sub-cache memory 115 of FIGS, according to an example embodiment;

FIG. 11A is a graph schematically illustrating access times of cache memories according to an example embodiment of the inventive concepts;

FIG. 11B is a graph schematically illustrating access times of cache memories according to an example embodiment of the inventive concepts;

FIG. 12A is a diagram for describing read operations of a main cache memory and a sub-cache memory, according to an example embodiment;

FIG. 12B is a diagram for describing read operations of a main cache memory and a sub-cache memory, according to an example embodiment;

FIG. 12C is a diagram for describing an operation where LSB data is written back to a main cache memory from a sub-cache memory, according to an example embodiment; and

FIG. 13 is a block diagram schematically illustrating an application processor and an external memory and an external chip communicating with the application processor, according to an example embodiment.

### DETAILED DESCRIPTION OF EXAMPLE EMBODIMENTS

Some example embodiments will be described in detail with reference to the accompanying drawings. The inventive concepts, however, may be embodied in various different forms, and should not be construed as being limited only to the illustrated embodiments. Rather, the example embodiments are provided as so that this disclosure will be thorough and complete, and will fully convey the inventive concepts to those skilled in the art. Accordingly, known processes, elements, and techniques are not described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing example embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

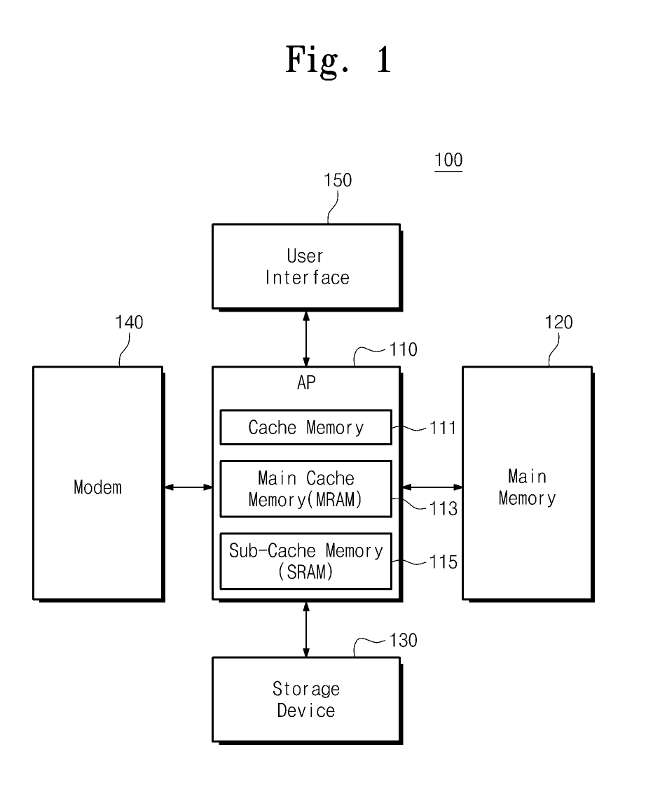

FIG. 1 a block diagram schematically illustrating a computing system 100 according to an example embodiment of the inventive concepts. Referring to FIG. 1, a computing system 100 may include an application processor 110, a main memory 120, a storage device 130, a modem 140, and a user interface 150.

The application processor 110 may control an overall operation of the computing system 100, and may perform a logical operation. For example, the application processor 110 may be formed of a System-on-Chip (SoC). The application processor 110 may include a cache memory 111, a main cache memory 113, and a sub-cache memory 115.

The cache memory 111 may be an L1 cache memory of the application processor 110. The main cache memory 113 and the sub-cache memory 115 may be L2 cache memories. The main cache memory 113 may include a nonvolatile memory, in particular, a magnetic random access memory (MRAM). The sub-cache memory 115 may include a static random access memory (SRAM).

The main cache memory 113 may exchange data with the cache memory 111 or the main memory 120 by the unit of data including LSB (Less Significant Bit) data and MSB (More Significant Bit) data. The sub-cache memory 115 may store LSB data of a part of data stored at the main cache memory 113.

The main memory 120 may be used as a working memory of the computing system 100. The main memory 120 may include a volatile memory (e.g., DRAM) or a nonvolatile memory (e.g., a phase-charge RAM (PRAM), a resistive RAM (RRAM), a ferroelectric RAM (FRAM), etc.).

The storage device 130 may be used as storage of the computing system 100. The storage device 130 may store data of the computing system 100 which is retained in the long term. The storage device 130 may include a hard disk drive or a nonvolatile memory such as a flash memory, a phase-change RAM (PRAM), a magnetic RAM (MRAM), a resistive RAM (RRAM), a ferroelectric RAM (FRAM), or the like.

In one example embodiment, the main memory 120 and the storage device 130 may be integrated in a memory. A first portion of the memory may be used as the main memory 120 and a second portion thereof may be used as the storage device 130.

The modem 140 may perform wired and/or wireless communication with an external device according to a control of the application processor 110. The modem 140 may communicate using at least one of a wired and/or wireless communications method including, but not limited to, WiFi, CDMA (Code Division Multiple Access), GSM (Global System for Mobile communication), LTE (Long Term Evolution), Bluetooth, NFC (Near Field Communication).

The user interface 150 may exchange data with an external device. For example, the user interface 150 may include user input interfaces such as a keyboard, a keypad, a button, a touch panel, a touch screen, a touch ball, a touch pad, a camera, a gyroscope sensor, a vibration sensor. The user interface 150 may include user output interfaces such as an LCD (Liquid Crystal Display), an OLED (Organic Light Emitting Diode) display device, an AMOLED (Active Matrix OLED) display device, an LED, a speaker, a motor.

Hereinafter, example embodiments of the inventive concepts will be described with reference to the main cache memory 113 and the main cache memory 113 that have a second level. In FIG. 1, there is described an example embodiment where the main cache memory 113 and the main cache memory 113 are L2 cache memories. However, the inventive concepts are not limited thereto.

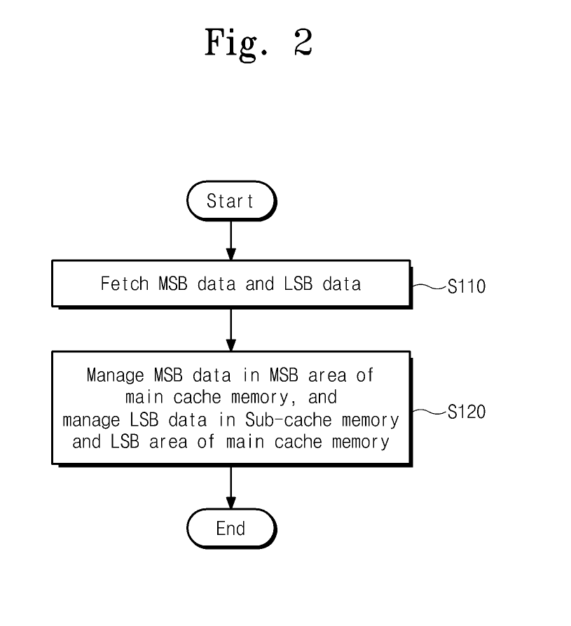

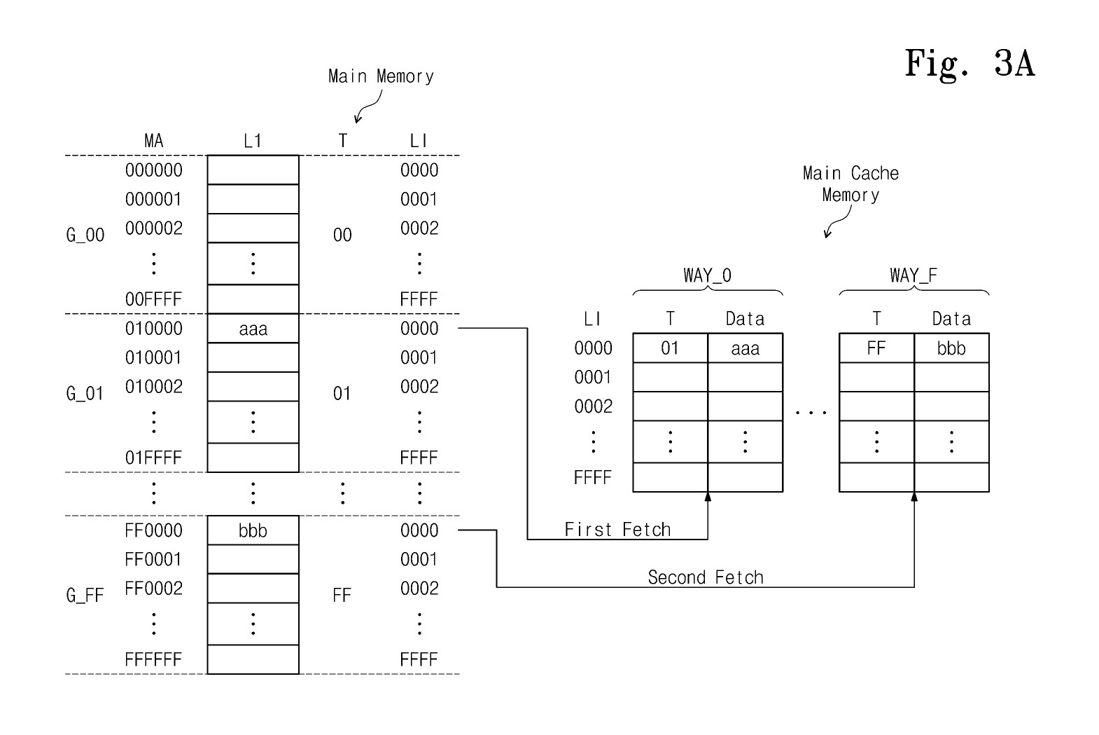

FIG. 2 is a flow chart schematically illustrating a data managing method of an application processor 110 of FIG. 1, according to an example embodiment. Referring to FIGS. 1 and 2, in operation S110, MSB data and LSB data may be fetched. In operation S120, the MSB data may be managed using an MSB area of a main cache memory 113, and the LSB data may be managed using an LSB area of the main cache memory 113 and a sub-cache memory 115.

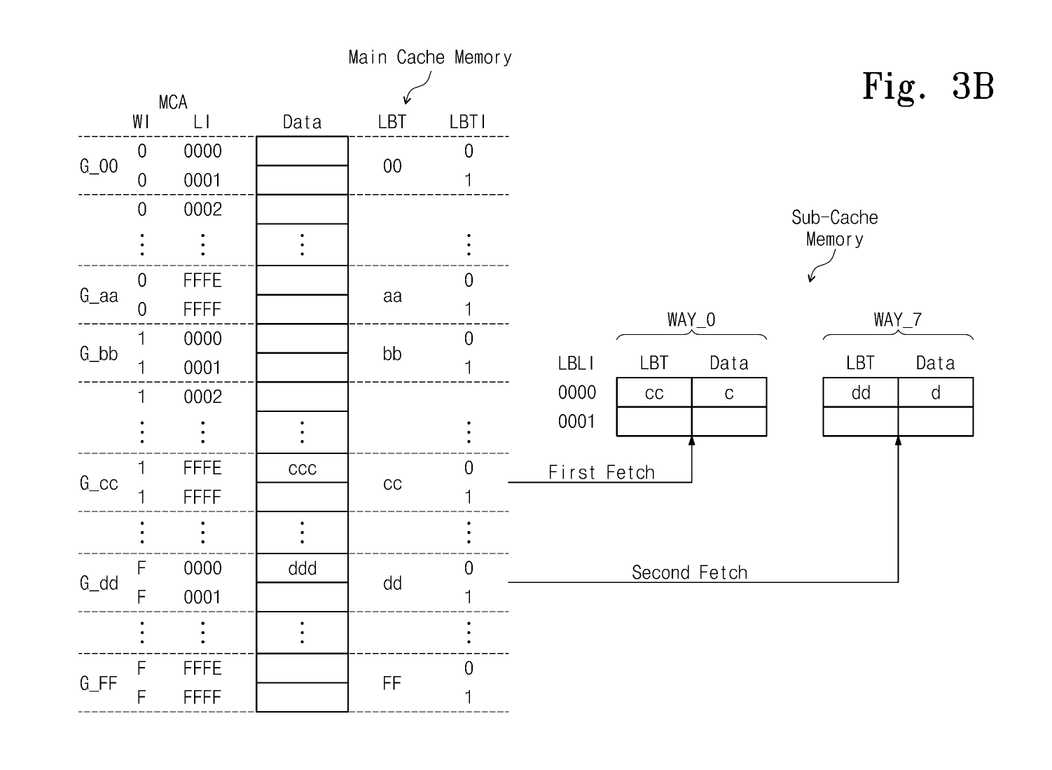

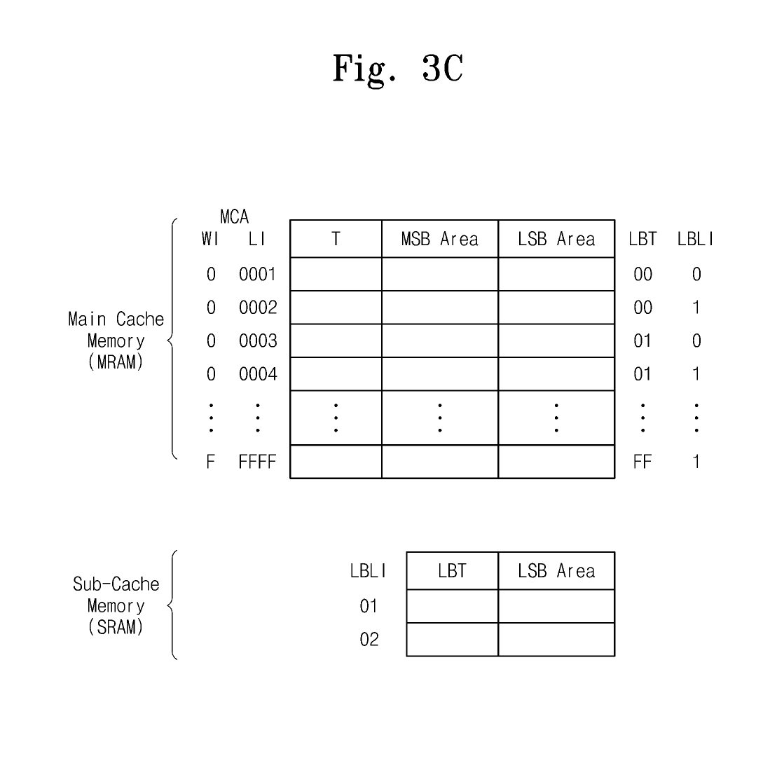

FIGS. 3A and 3B are diagrams illustrating relations among a main memory 120, a main cache memory 113, and a sub-cache memory 115 of FIG. 1, according to an example embodiment. Referring to FIGS. 1 and 3A, a main memory 120 may store data by units of lines. A line may be a data transfer data of an application processor 110 or a cache memory of the application processor 110. Lines of the main memory 120 may be distinguished and accessed by a main memory address MA.

The main memory 120 may be divided into a plurality of groups G_{—}00 to G_FF, each of which includes a plurality of lines. The groups G_{—}00 to G_FF may be configured to have the same size.

A tag T may be assigned to each of the groups G_{—}00 to G_FF. Line indexes LI may be assigned to lines of the groups G_{—}00 to G_FF, respectively. For example, the same line index LI may be assigned to lines in each of the groups G_{—}00 to G_FF. An index 0000 of a first line of the first group G_{—}00 may be equal to an index 0000 of a first line of the second group G_{—}01.

The main cache memory 113 may access the main memory 120 based on the tag T and the line index LI assigned to the main memory 120. For example, the main cache memory 113 may fetch data from the main memory 120 or write data back at the main memory 120, based on the tag T and the line index LI assigned to the main memory 120. The main cache memory 113 may be a set associative cache memory which operates based on the main memory 120.

The main cache memory 113 may include a plurality of ways WAY_{—}0˜WAY_F. Each of the ways WAY_{—}0˜WAY_F may include lines the number of which is equal to that of a group of the main memory 120. The number of ways WAY_{—}0·WAY_F may be less than that of groups G_{—}00 to G_FF of the main memory 120. That is, a size of the main cache memory 113 may be less than that of the main memory 120.

The line index LI assigned to each group of the main memory 120 and the line index LI assigned to each group of the main cache memory 113 may be associated. For example, data stored at a particular line of each group of the main memory 120 may be fetched into a line of the main cache memory 113 placed at the same location. Data stored at lines of the main memory 120 placed at the same location and belonging to different groups may be fetched into different ways of the main cache memory 113 belonging to lines placed at the same location.

For example, data “aaa” placed at a first line “0000” of a group G_{—}01 in the main memory 120 may be fetched into a first line “0000” of a way WAY_{—}0 of the main cache memory 113. The fetched data may be stored with a tag (T, 01) indicating a location of a group of the main memory 120. Data “bbb” placed at a first line “0000” of a group G_FF in the main memory 120 may be fetched into a first line “0000” of another way WAY_F of the main cache memory 113. The fetched data may be stored with a tag (T, FF) indicating a location of a group of the main memory 120.

The data “aaa” fetched into the first line “0000” of the way WAY_{—}0 of the main cache memory 113 may be written back at a first line of the group G_{—}01 of the main memory 120, based on an line index (LI, 0000) and a tag (T, 01). The data “bbb” fetched into the first line “0000” of the way WAY_F of the main cache memory 113 may be written back at a first line of the group G_FF of the main memory 120, based on an line index (LI, 0000) and a tag (T, FF).

Referring to FIGS. 1, 3A, and 3B, lines of the main cache memory 113 may be distinguished and accessed by a main cache memory address MCA. The main cache memory address MCA may be distinguished and accessed by a way information WI and a line index LI of the main cache memory 113. The way information WI may include information associated with locations of ways WAY_{—}0˜WAY_F of the main cache memory 113.

The main cache memory 113 may be divided into a plurality of groups G_{—}00 to G_FF, each of which includes a plurality of lines. The groups G_{—}00 to G_FF may have the same size.

An LSB tag LBT may be assigned to each of the groups G_{—}00 to G_FF. LSB line indexes LBLI may be assigned to lines of the groups G_{—}00 to G_FF. For example, the same line index LI may be assigned to lines of each of the groups G_{—}00 to G_FF. An index “0000” of a first line of the first group GOO may be equal to an index “0000” of a first line of a second group G_{—}01.

The sub-cache memory 115 may access the main cache memory 113 based on the LSB tag LBT and the LSB line index LBLI assigned to the main cache memory 113. For example, the sub-cache memory 115 may fetch data from the main cache memory 113 or write data back at the main cache memory 113, based on the LSB tag T and the LSB line index LBLI assigned to the main cache memory 113. The sub-cache memory 115 may be a set associative cache memory which operates based on the main cache memory 113.

The sub-cache memory 115 may include a plurality of ways WAY_{—}0 to WAY_{—}7. Each of the ways WAY_{—}0 to WAY_{—}7 may include lines the number of which is equal to that of a group of the main cache memory 113. The number of ways WAY_{—}0 to WAY_{—}7 may be less than that of groups G_{—}00 to G_FF of the main cache memory 113. That is, a size of the sub-cache memory 115 may be less than that of the main cache memory 113.

The LSB line index LBLI assigned to each group of the main cache memory 113 and the LSB line index LBLI assigned to each group of the sub-cache memory 115 may be associated. For example, LSB data stored at a particular line of each group of the main cache memory 113 may be fetched into a line of the sub-cache memory 115 placed at the same location. LSB data stored at lines of the main cache memory 113 placed at the same location and belonging to different groups may be fetched into different ways of the sub-cache memory 115 belonging to lines placed at the same location.

For example, data “ccc” placed at a first line “0000” of a group G_cc in the main cache memory 113 may be fetched into a first line “0” of a way WAY_{—}0 of the sub-cache memory 115. The fetched data may be stored with an LSB tag (LBT, cc) indicating a location of a group of the main cache memory 113. LSB data “ddd” placed at a first line “0000” of a group G_dd in the main cache memory 113 may be fetched into a first line “0” of another way WAY_{—}7 of the sub-cache memory 115. The fetched data may be stored with an LSB tag (LBT, dd) indicating a location of a group of the main cache memory 113.

The LSB data “a” fetched into the first line “0” of the way WAY_{—}0 of the sub-cache memory 115 may be written back at a first line of the group G_cc of the main cache memory 113, based on an LSB line index (LBLI, 0) and an LSB tag (LBT, cc). The LSB data “d” fetched into the first line “0” of the way WAY_{—}7 of the sub-cache memory 115 may be written back at a first line of the group G_dd of the main cache memory 113, based on an LSB line index (LBLI, 0) and an LSB tag LBT (LBT, dd).

FIGS. 3A and 3B are described under such an assumption that the main cache memory 113 and the sub-cache memory 115 have particular sizes. However, sizes of the main cache memory 113 and the sub-cache memory 115 may not be limited to example embodiments described with reference to FIGS. 3A and 3B.

FIG. 3C is a diagrams schematically illustrating a main cache memory 113 and a sub-cache memory 115 of FIG. 3A, according to an example embodiment. In the example embodiment of FIG. 3C, a main cache memory 113 and a sub-cache memory 115 associated with a way are illustrated. Below, it is assumed that the remaining ways of the sub-cache memory 115 other than the way illustrated in FIG. 3C store valid data. That is, the main cache memory 113 and the sub-cache memory 115 will be described using a way of the sub-cache memory 115.

Referring to FIGS. 1 to 3C, each of lines of the main cache memory 113 may be divided into an MSB area and an LSB area. The MSB area may store data, corresponding to a first portion (MSB data) placed at an MSB side, from among data stored at a line, and the LSB area may store data, corresponding to a second portion (LSB data) placed at an LSB side, from among data stored at a line. A reference for dividing data corresponding to a line into MSB data and LSB data may be set by the application processor 110, during manufacturing of the application processor 110, during manufacturing of the computing system 100.

The sub-cache memory 115 may include a plurality of sub-lines. A sub-line may correspond to an LSB area of a line of the main cache memory 113.

MSB data of data managed (e.g., stored, updated and output) in L2 cache memories (e.g., main cache memory 113 and sub-cache memory 115) may be managed in an MSB area of the main cache memory 113, and LSB data may be managed in an LSB area of the main cache memory 113 and the sub-cache memory 115.

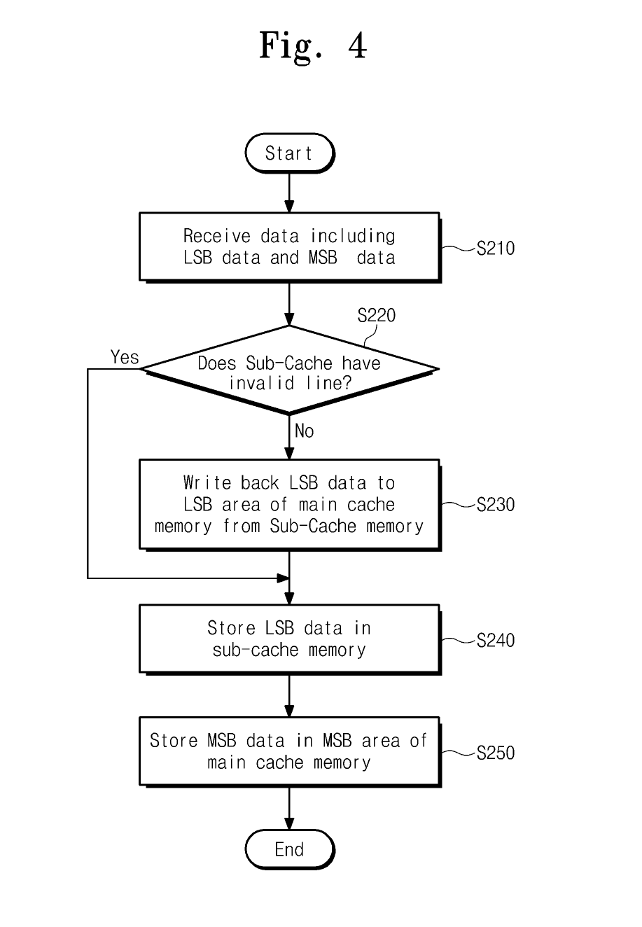

FIG. 4 is a flow chart of a method for storing data at cache memories 113 and 115 of FIG. 3C, according to an example embodiment. Referring to FIGS. 3C and 4, at S210, the application processor 110 may receive data including LSB data and MSB data. For example, the application processor 110, at a main cache memory 113 and a sub-cache memory 115 of the application processor 110, may receive data from an upper cache memory, a lower cache memory or the main memory 120. An address may be received together with data. For example, a line index LI and a tag T associated with the data may be received.

At S220, the application processor 110 may determine whether a sub-cache memory 115 includes an invalid sub line. In one example embodiment, the invalid sub line may include a sub line where data is not stored or a sub line where invalid data is stored. If the sub-cache memory 115 does not include an invalid sub line, at S230, LSB data may be written back or flushed from the sub-cache memory 115 to a main cache memory 113. For example, LSB data stored at a selected sub line of the sub-cache memory 115 may be written back at a corresponding line of the main cache memory 113. For example, earliest accessed LSB data of LSB data stored at the sub-cache memory 115 may be written back. A line where LSB data written back is stored may be invalidated.

If the sub-cache memory 115 includes an invalid sub line, the method may proceed to operation S240.

At S240, the application processor 110 may store LSB data of input data, at the sub-cache memory 115. For example, LSB data may be stored at an empty sub line where data of the sub-cache memory 115 is not stored or an invalid sub line.

At S250, the application processor 110 may store MSB data of the input data at an MSB area of the main cache memory 113.

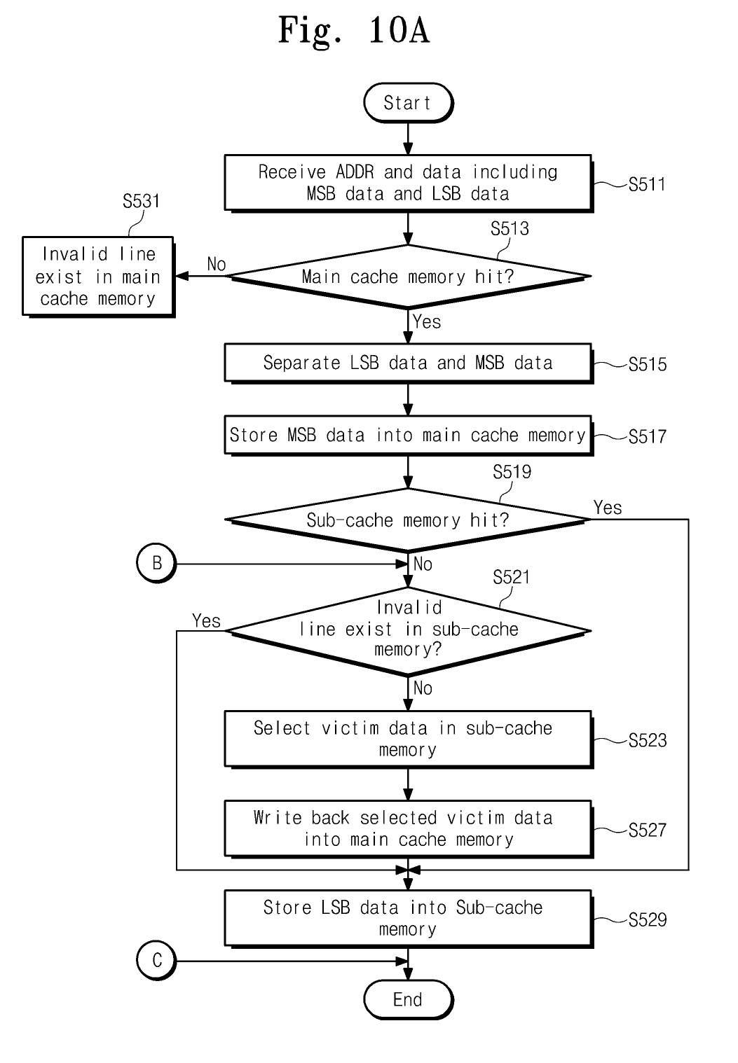

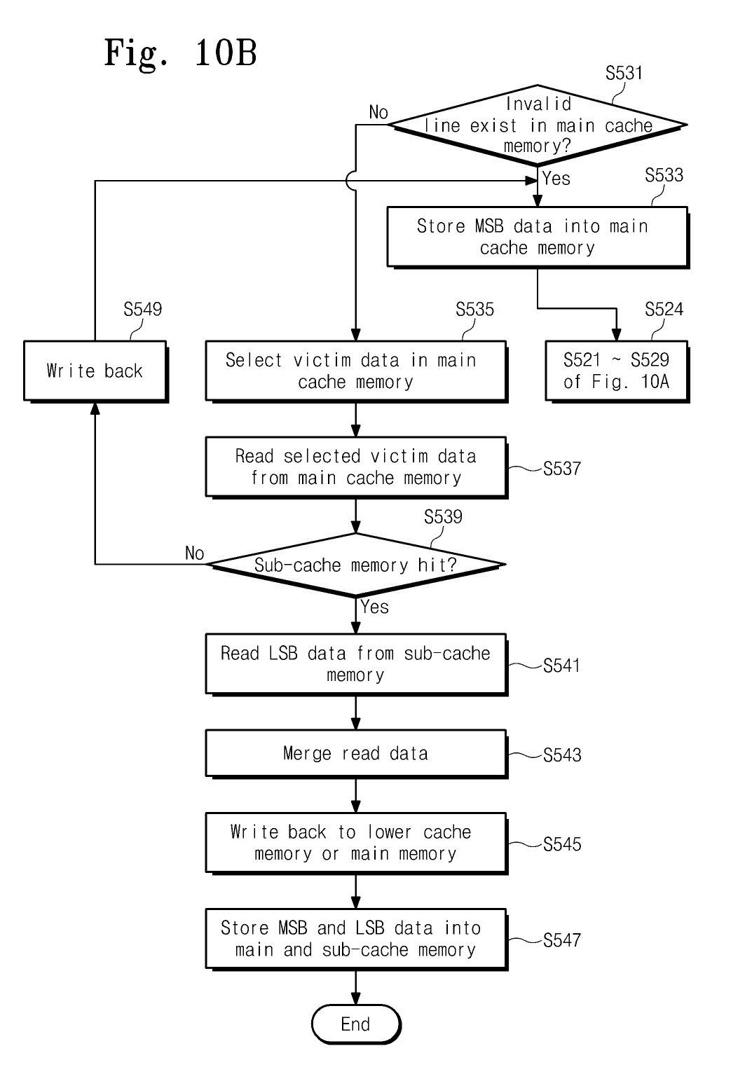

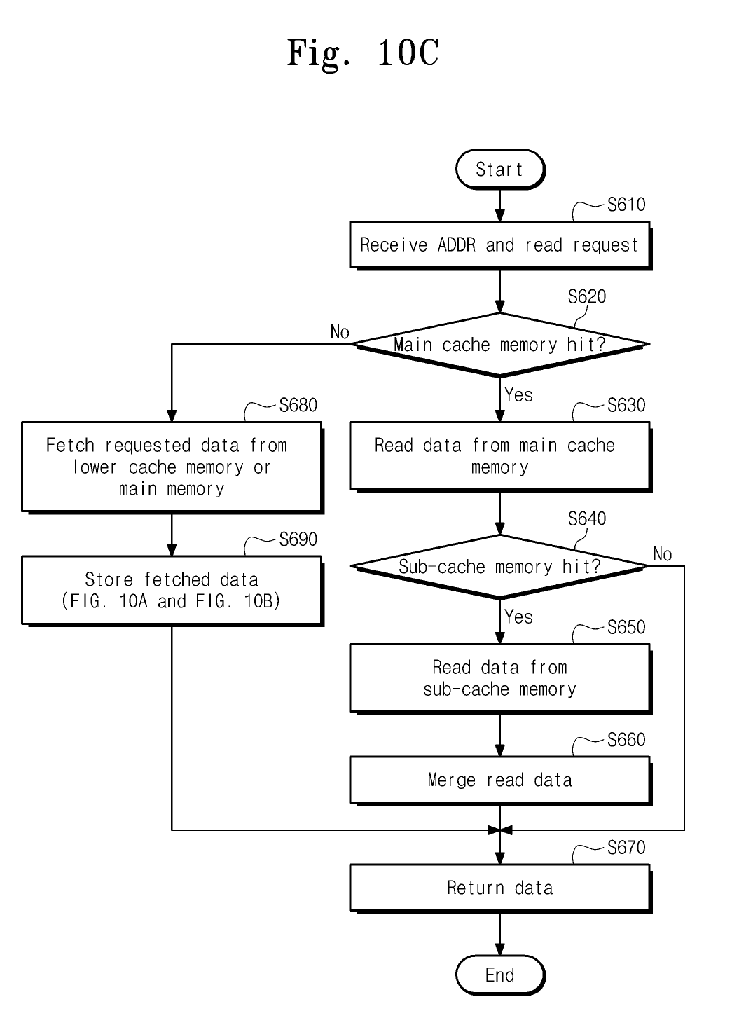

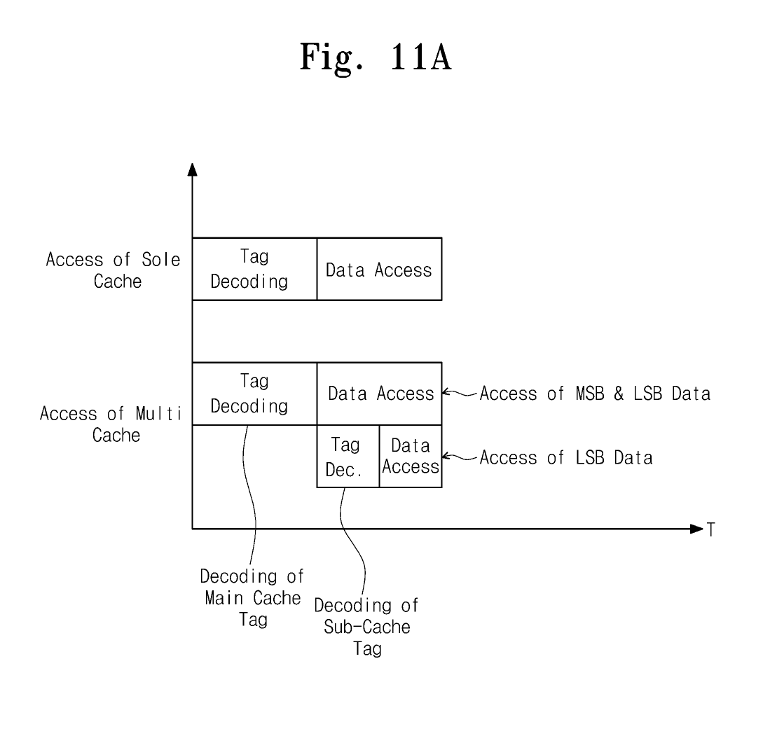

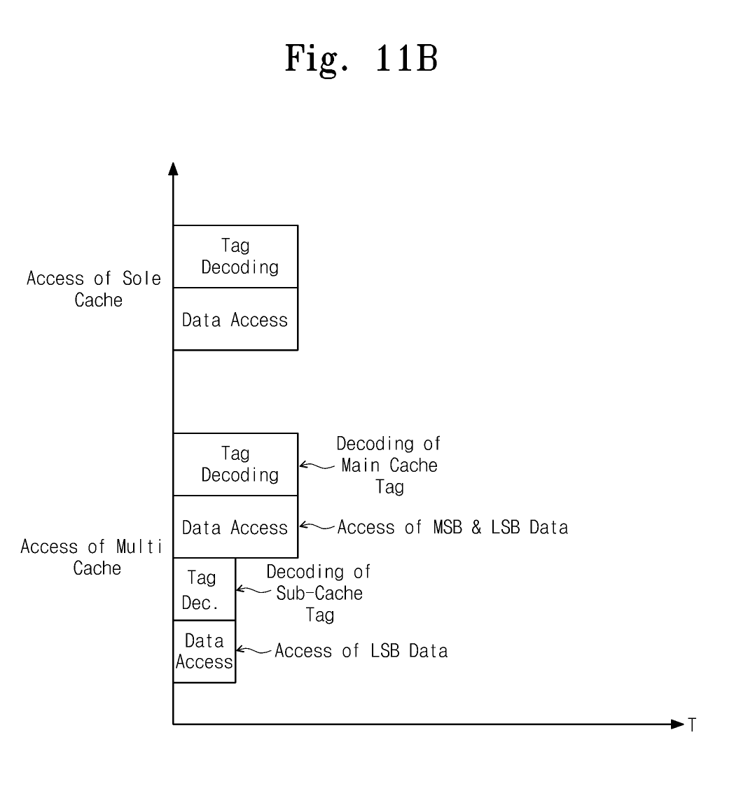

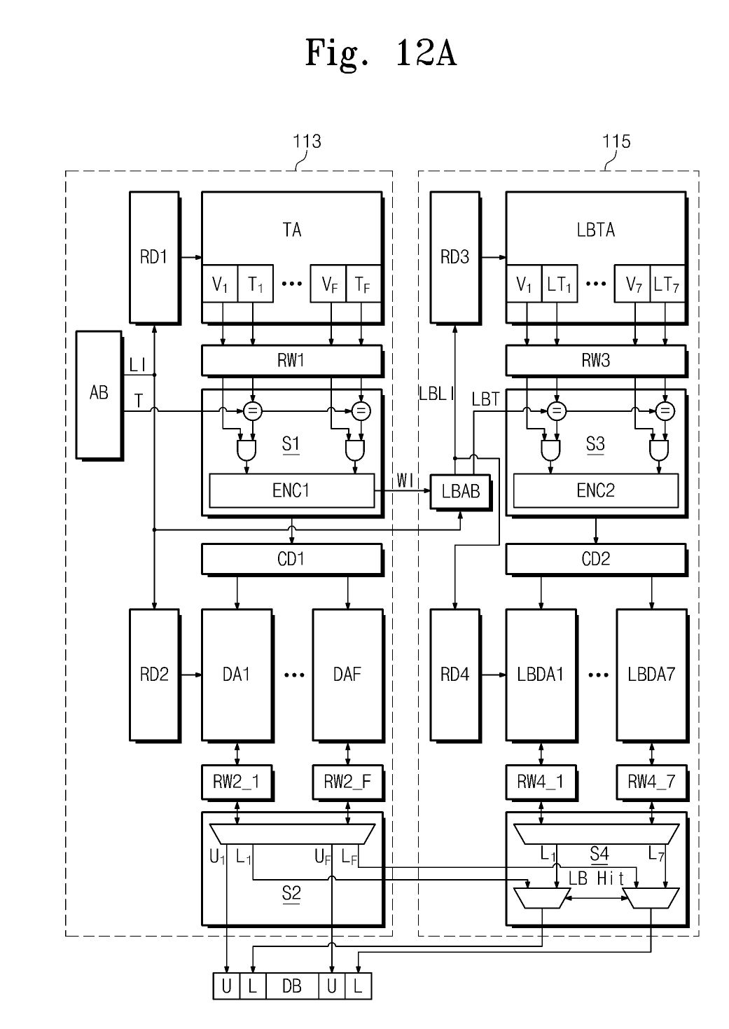

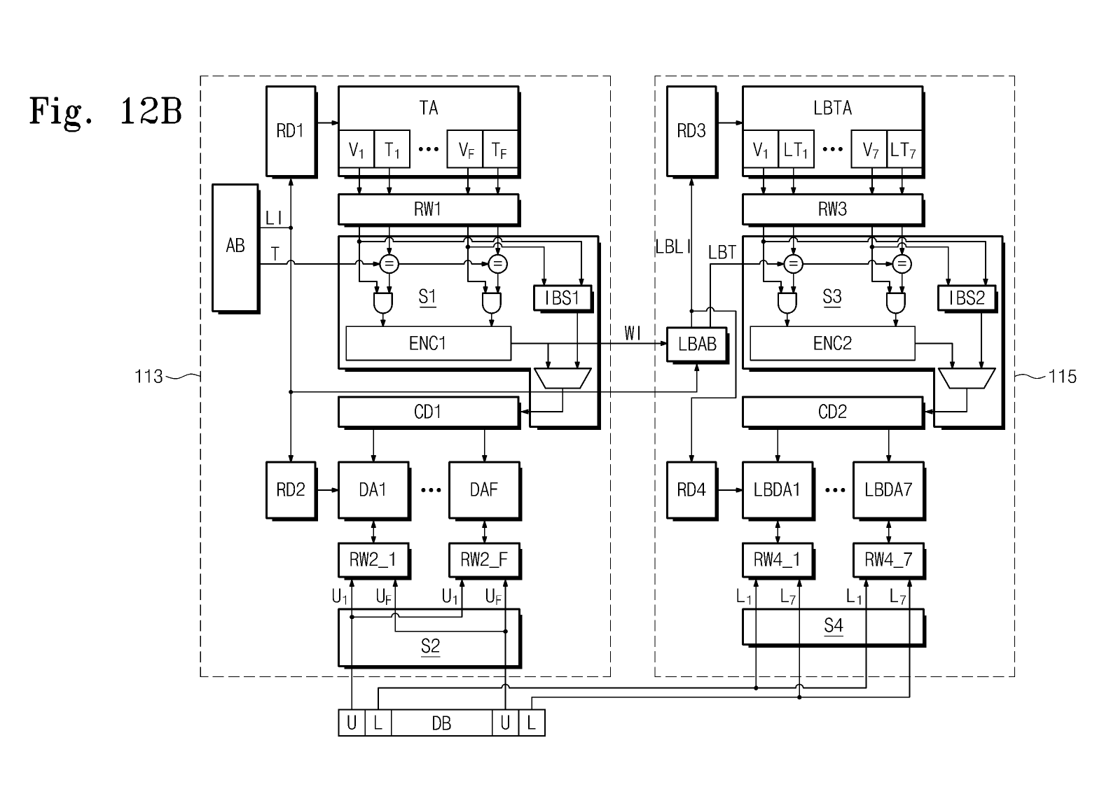

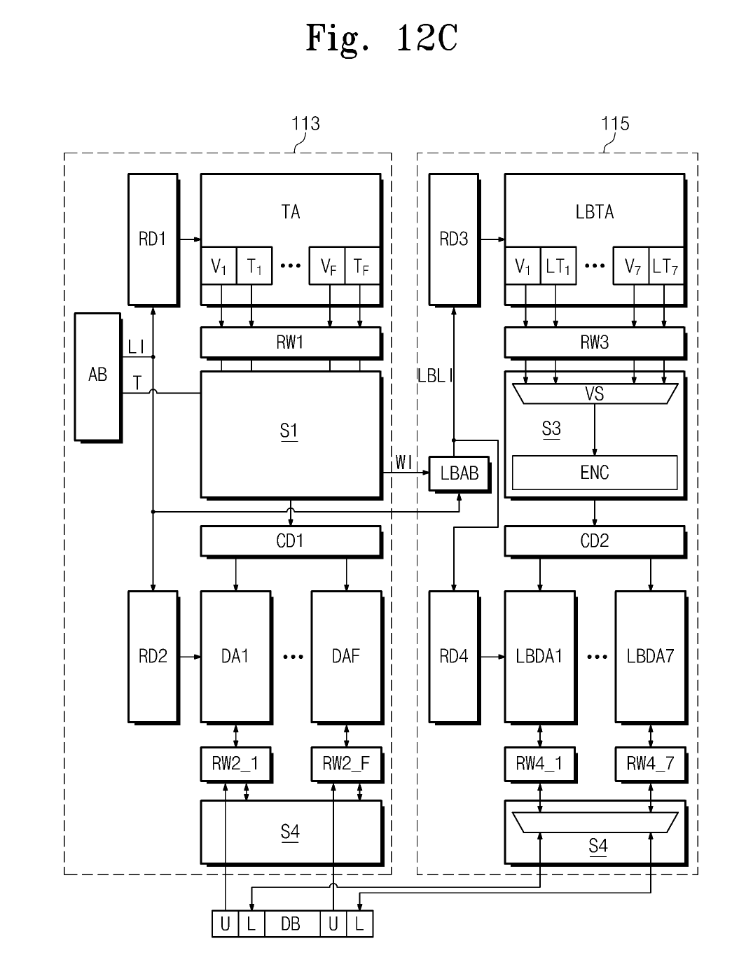

In the described example embodiments, S220 to S240 may form an operation of storing LSB data, while S250 may be an operation of storing MSB data. The operation of storing LSB data and the operation of storing MSB data may be performed in parallel or sequentially. When the main cache memory 113 does not include an invalid line, a write-back operation may be performed at the main cache memory 113. This will be more fully described with reference to FIGS. 10A and 10B.

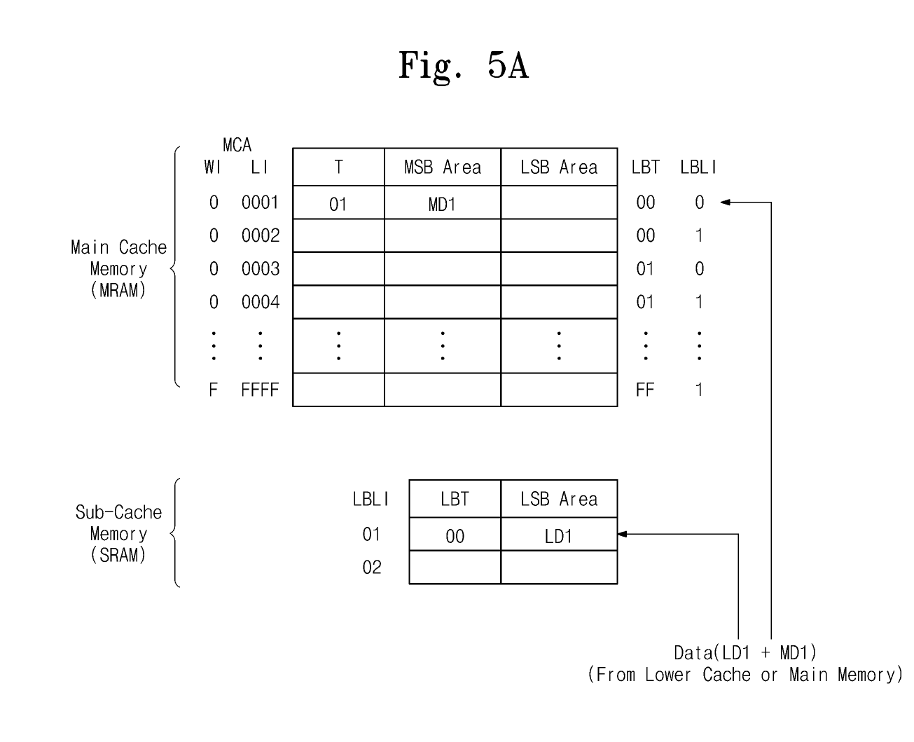

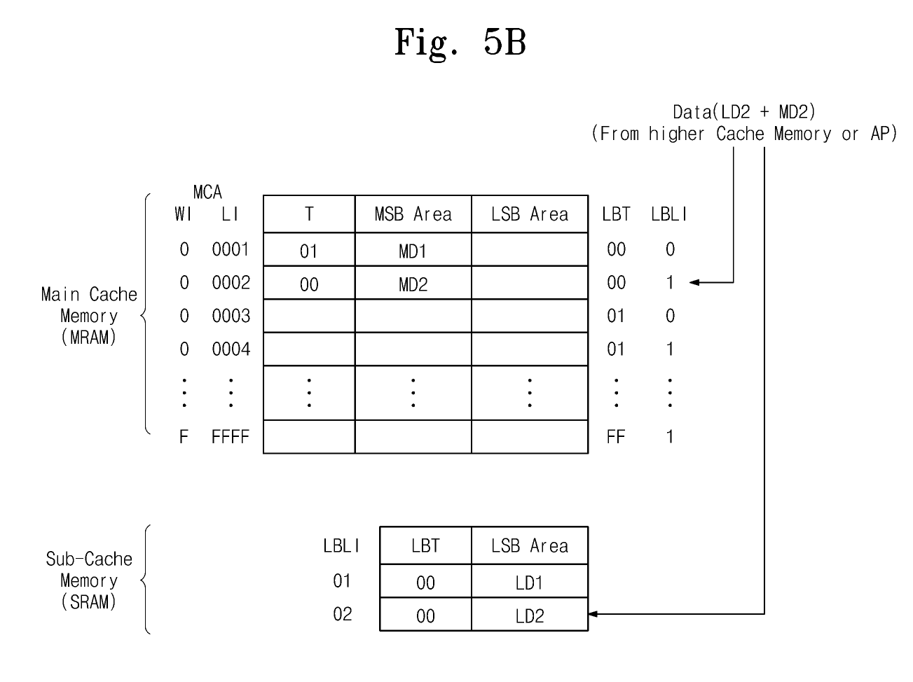

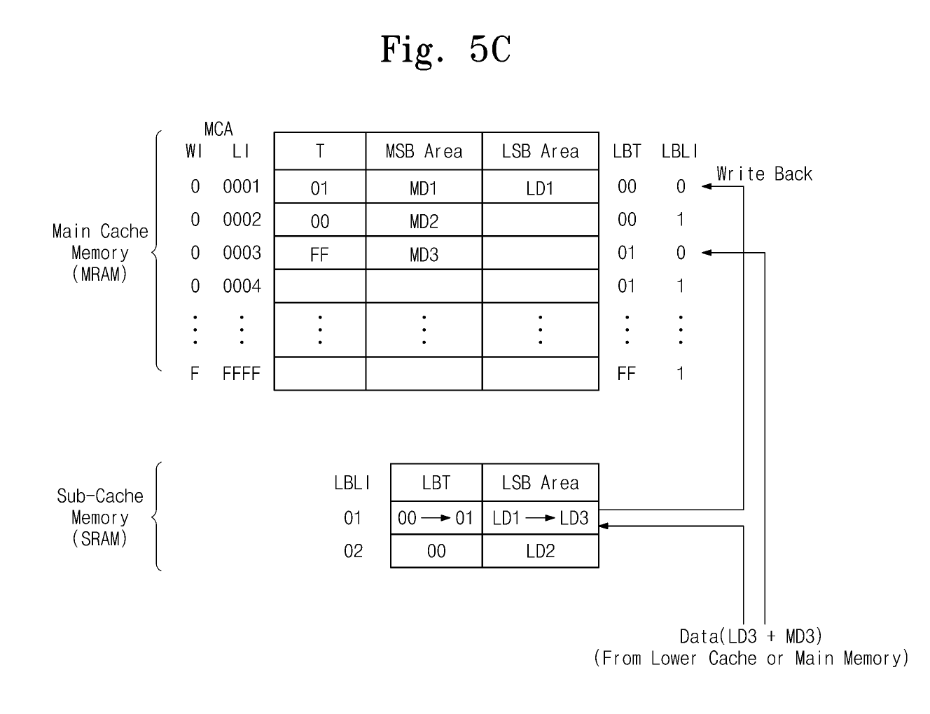

FIGS. 5A to 5C are block diagrams schematically illustrating example embodiments where a storing method of FIG. 4 is executed at a cache structure of FIG. 3C. Referring to FIGS. 1, 4, and 5A, a main cache memory 113 and a sub-cache memory 115 may receive data including LSB data LD1 and MSB data MD1. For example, data may be received from a lower cache or a main memory 120.

In one example embodiment, it is assumed that the main cache memory 113 and the sub-cache memory 115 are at an empty state.

Since the sub-cache memory 115 includes an invalid sub line, the application processor 110 may not generate a write-back operation of the sub-cache memory 115.

The application processor 110 may store MSB data MD1 of the input data at an MSB area of a selected line of the main cache memory 113. The application processor 110 may store the MSB data MD1 at a line having a selected line index LI together with a tag T indicating a lower cache or the main memory 120.

LSB data LD1 of the input data may be stored at a selected sub line of the sub-cache memory 115. The LSB data LD1 may be stored at a line having a selected LSB line index LBLI together with an LSB tag LBT indicating a lower cache or the main cache memory 113.

Referring to FIGS. 1, 4, and 5B, the main cache memory 113 and the sub-cache memory 115 may receive data including LSB data LD2 and MSB data MD2. For example, data may be received from an upper cache 111 or an application processor 110.

Since the sub-cache memory 115 includes an invalid sub line, the application processor 110 may not generate a write-back operation of the sub-cache memory 115.

The application processor 110 may store MSB data MD2 of the input data at an MSB area of a selected line of the main cache memory 113. The application processor 110 may store LSB data LD2 of the input data at a selected sub line of the sub-cache memory 115.

Referring to FIGS. 1, 4, and 5C, the main cache memory 113 and the sub-cache memory 115 may receive data including LSB data LD3 and MSB data MD3. For example, data may be received from a lower cache or the main memory 120.

Since the sub-cache memory 115 does not include an invalid sub line, the application processor 110 may generate a write-back operation of the sub-cache memory 115. In one example embodiment, the application processor 110 may write back LSB data LD1 stored at a first sub line of the sub-cache memory 115. An address (e.g., a tag T and a line index LI) of the main cache memory 113 where MSB data MD1 corresponding to selected LSB data LD1 is stored may be detected based on an LSB line index LBLI and an LSB tag LBT corresponding to the selected LSB data LD1. The application processor 110 may write back the LSB data LD1 at an LSB area of a line of the main cache memory 113 corresponding to the detected address. The application processor 110 may then invalidate a sub line of the sub-cache memory 115 where the LSB data LD1 written back is stored.

The application processor 110 may store MSB data MD3 of the input data at an MSB area of a selected line of the main cache memory 113.

The application processor 110 may store LSB data LD3 of the input data at a selected sub line of the sub-cache memory 115. The LSB data LD3 may be stored at a sub line which is invalidated according to a write-back operation.

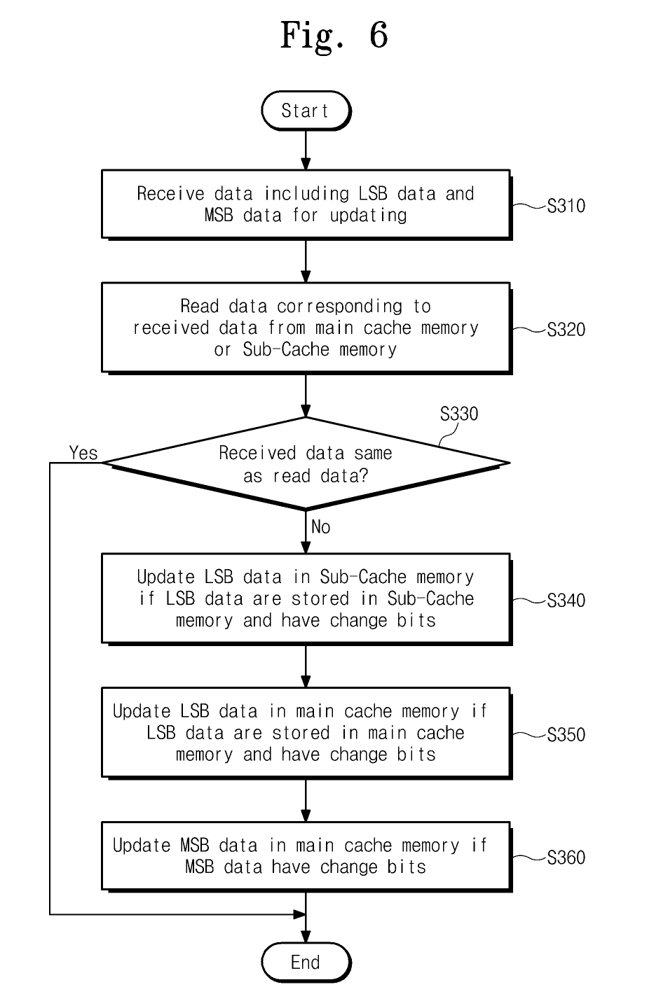

FIG. 6 is a flow chart schematically illustrating a method of updating data of cache memories 113 and 115 of FIG. 3C, according to an example embodiment. Referring to FIGS. 1, 3C, and 6, at S310, the application processor 110 may receive update data including LSB data and MSB data. Data may be received from an upper cache memory, an application processor, a lower cache memory, or a main memory. A line index and a tag associated with data may be received together with the data.

At S320, the application processor 110 may receive data corresponding to the input data from a main cache memory 113 or a sub-cache memory 115. For example, in the event that data is scattered into the main cache memory 113 and the sub-cache memory 115, the application processor 110 may read data from the main cache memory 113 and the sub-cache memory 115. If data is only stored at the main cache memory 113, data may be read from the main cache memory 113.

At S330, the application processor 110 may compare the read data with the input data (e.g., determine whether there are any change bits). If, at S330, the application processor 110 determines that the read data and the input data are the same, the process may end.

However, if at S330, the application processor 110 determines that the received data is not the same as the input data, then at S340, if LSB data is stored at the sub-cache memory 115 and has change bits, the application processor 110 may update LSB data stored at the sub-cache memory 115. For example, when the comparison result indicates that the LSB data is changed, the application processor 110 may determine that the LSB data may be determined t have change bits.

At S350, if LSB data is stored at the main cache memory 113 and has change bits, the application processor 110 may update LSB data stored at the main cache memory 113.

At S360, when MSB data has change bits, the application processor 110 may update MSB data stored at the main cache memory 113. For example, when the comparison result indicates that the MSB data is changed, the application processor 110 may determine that the MSB data have change bits.

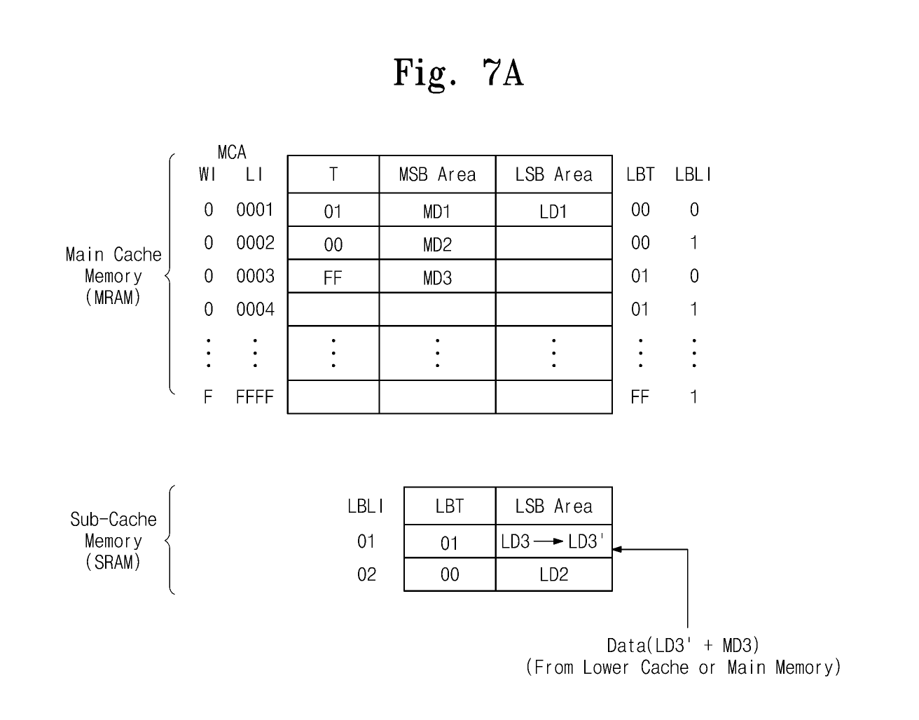

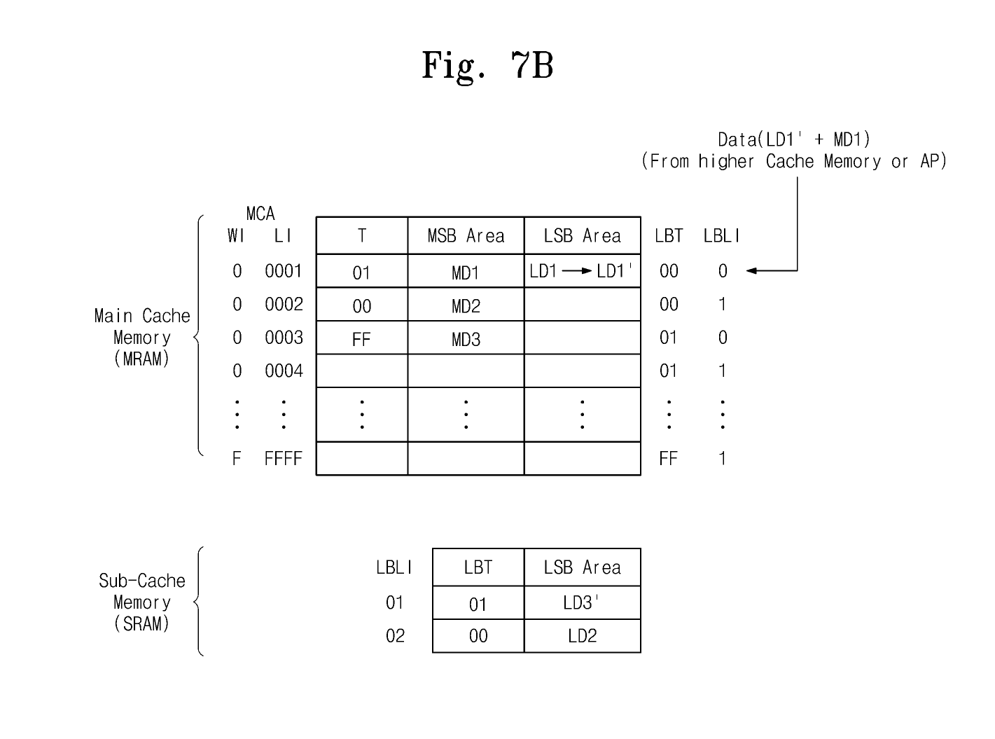

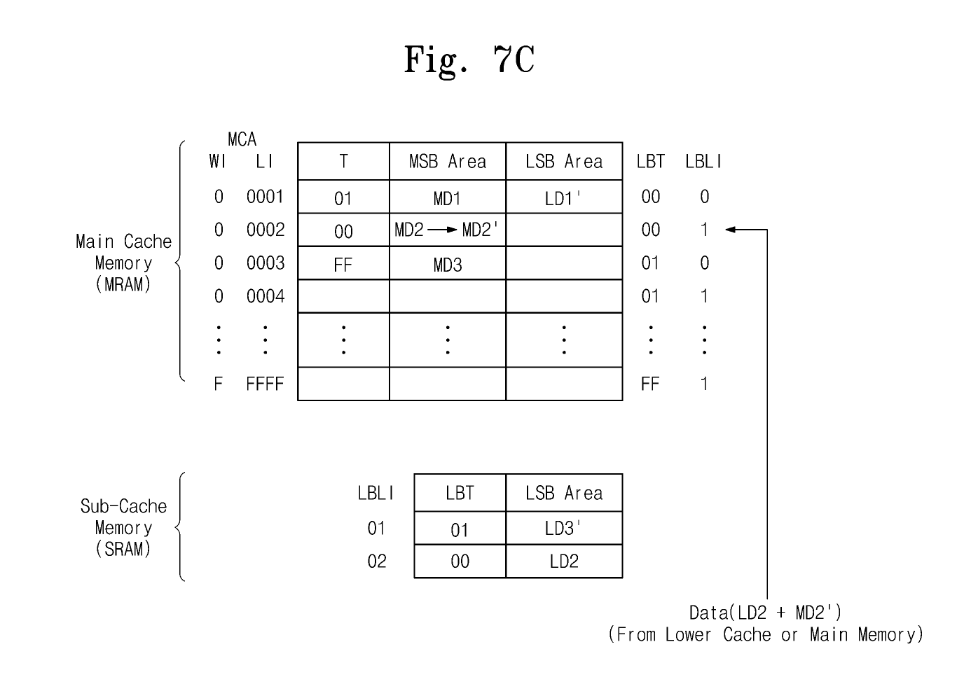

FIGS. 7A to 7C are block diagrams schematically illustrating example embodiments where a storing method of FIG. 6 is executed at a cache structure of FIG. 3C. Referring to FIGS. 6 and 7A, the application processor 110 may receive data via a main cache memory 113 and a sub-cache memory 115 of the application processor 110. The receive data may include LSB data LD3′ and MSB data MD3. For example, data may be received from a lower cache or a main memory 120.

The MSB data MD3 of update data may be equal to MSB data MD3 stored at the main cache memory 113. Thus, the application processor 110 may determine that the MSB data do not have change bits. In this case, the application processor 110 may not update the MSB data.

The LSB data LD3′ of the update data may be different from LSB data LD3 stored at the sub-cache memory 115. Thus, the application processor 110 may determine that the LSB data do not have change bits. In this case, the application processor 110 may update the LSB data stored at the sub-cache memory 115, with new data LD3′.

Referring to FIGS. 6 and 7B, the main cache memory 113 and the sub-cache memory 115 may receive data including LSB data LD1′ and MSB data MD1. For example, data may be received from an upper cache 111 or an application processor 110.

The MSB data MD1 of update data may be equal to MSB data MD1 stored at the main cache memory 113. Thus, the application processor 110 may determine that the MSB data do not have change bits. In this case, the application processor 110 may not update the MSB data.

The LSB data LD1′ of the update data may be different from LSB data LD1 stored at the main cache memory 113. Thus, the application processor 110 may determine that the LSB data do not have change bits. In this case, the application processor 110 may update the LSB data stored at the main cache memory 113, with new data LD1′.

Referring to FIGS. 6 and 7C, the main cache memory 113 and the sub-cache memory 115 may receive data including LSB data LD2 and MSB data MD2′. For example, data may be received from a lower cache or the main memory 120.

The MSB data MD2′ of the update data may be different from MSB data MD2 stored at the main cache memory 113. Thus, the application processor 110 may determine that the MSB data have change bits. In this case, the application processor 110 may update the MSB data MD2 stored at the main cache memory 113, with new data MD2′.

The LSB data LD2 of update data may be equal to LSB data LD2 stored at the sub-cache memory 115. Thus, the application processor 110 may determine that the LSB data LD2 do not have change bits. In this case, the application processor 110 may not update the LSB data LD2.

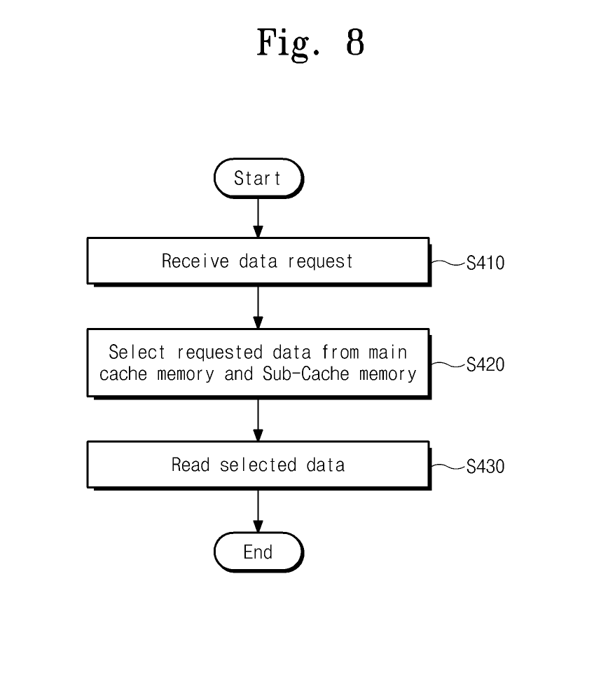

FIG. 8 is a flow chart schematically illustrating a method where a read operation is executed at cache memories of FIG. 3C, according to an example embodiment. Referring to FIGS. 3C and 8, at S410, a data request may be received. An address of data may be received together with the data. For example, a line index LI and a tag T associated with data may be received.

At S420, the application processor 110 may select data requested from a main cache memory 113 and a sub-cache memory 115.

At S430, the selected data may be read.

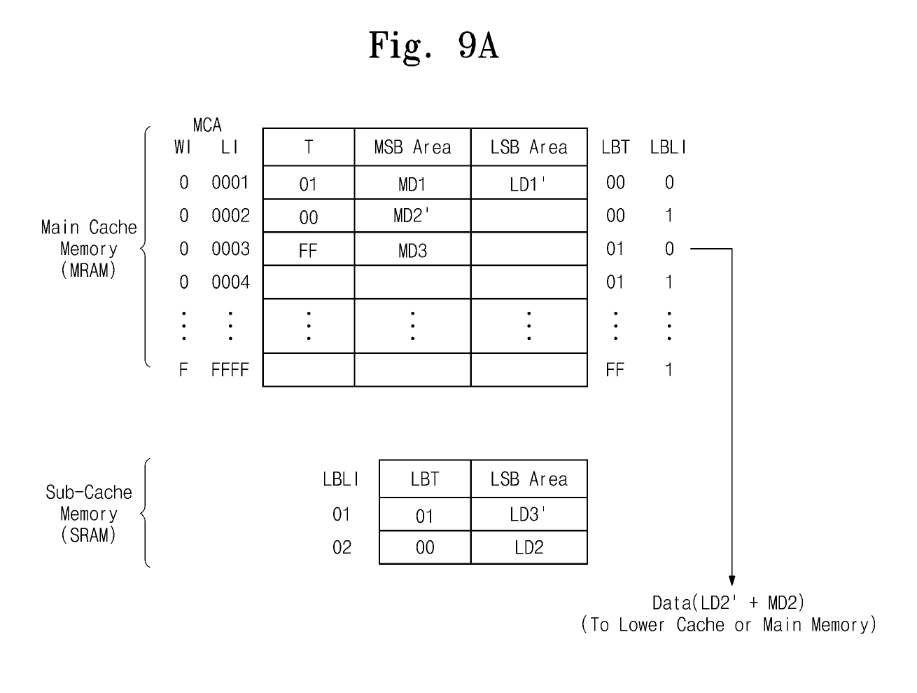

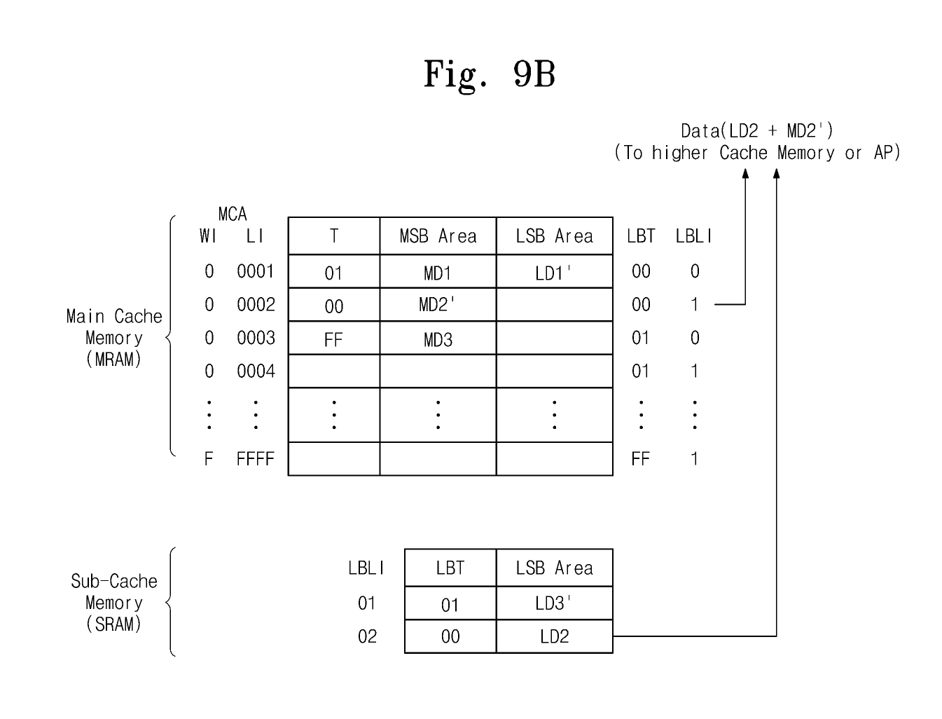

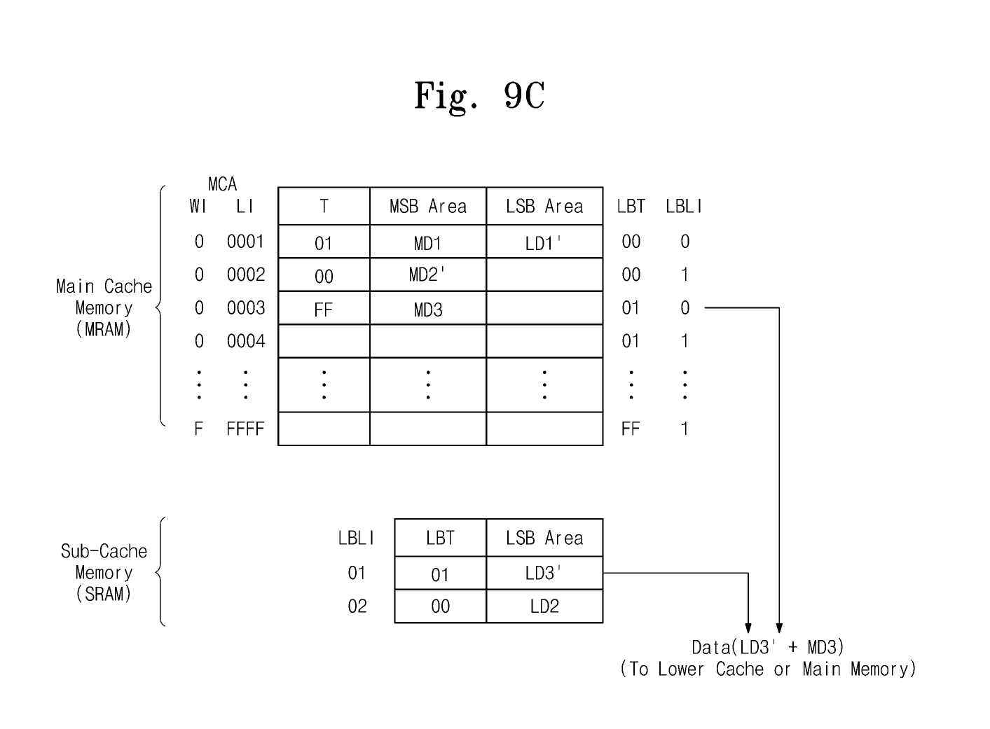

FIGS. 9A to 9C are block diagrams schematically illustrating example embodiments where a read method of FIG. 8 is executed at a cache structure of FIG. 3. Referring to FIGS. 8 and 9A, a data request for data stored at a first line of a main cache memory 113 may be received.

MSB data MD1 of a selected line may be stored at an MSB area of the main cache memory 113, and LSB data LD1′ may be stored at an LSB area of the main cache memory 113. Thus, the application processor 110 may read the MSB data MD1 and the LSB data LD1′ from the main cache memory 113. The read data may be output to a lower cache or a main memory 120, for example.

Referring to FIGS. 8 and 9B, a data request on data stored at a second line of the main cache memory 113 may be received.

MSB data MD2′ of a selected line may be stored at an MSB area of the main cache memory 113, and LSB data LD2′ may be stored at a sub-cache memory 115. Thus, the application processor 110 may read the MSB data MD2′ from the main cache memory 113, and the LSB data LD2 from the sub-cache memory 115. The application processor 110 may output the read data to an upper cache 111, for example.

Referring to FIGS. 8 and 9C, a data request on data stored at a third line of the main cache memory 113 may be received.

MSB data MD3 of a selected line may be stored at an MSB area of the main cache memory 113, and LSB data LD3′ may be stored at the sub-cache memory 115. Thus, the application processor 110 may read the MSB data MD3 from the main cache memory 113, and the LSB data LD3′ from the sub-cache memory 115. The application processor 110 may output read data to a lower cache or the main memory 120, for example.

As described above, a cache memory, having a particular level, of the application processor 110 may be formed of the main cache memory 113 and the sub-cache memory 115. The main cache memory 113 may include a plurality of lines, each of which is formed of an MSB area and an LSB area. The sub-cache memory 115 may include a plurality of sub lines corresponding to LSB areas of the main cache memory 113.

The application processor 110 may directly store MSB data of data input to the cache memories 113 and 115 at the main cache memory 113, and may buffer LSB data through the sub-cache memory 115. Then, the application processor 110 may store the buffered LSB data at the main cache memory 113.

In operations of an application processor and operations of an application executed by the application processor, LSB data may be updated more frequently than MSB data. That is, in the cache memories 113 and 115, an update frequency of LSB data may be higher than that of MSB data.

A magnetic RAM (MRAM) may be a nonvolatile memory and may not consume power to store data. Thus, the MRAM is applicable to a cache memory, having a particular level, of an application processor to reduce power consumption of the application processor.

However, when the MRAM executes a write operation, it may consume a lot of power compared to a conventional cache memory (e.g., SRAM or DRAM). That is, in the event that the MRAM is used as a cache memory to reduce power consumed to retain data, a lot of power may be consumed to update data.

In one example embodiment of the inventive concepts, LSB data having a high update frequency may be buffered by the sub-cache memory 115 formed of an SRAM. While LSB data is stored at the sub-cache memory 115, it may be updated using the sub-cache memory 115 which has a less write power than that of the MRAM. Thus, power consumed to retain data may be reduced, and power consumed to update data may be also reduced.

FIGS. 10A and 10B are flow charts schematically illustrating example embodiment where data is written at a main cache memory 113 and a sub-cache memory 115 of FIGS. 1, 3A and 3B. Referring to FIGS. 1, 3A, 3B, 10A, and 10B, at S511, the application processor 110 may receive an address (ADDR) and data including MSB data and LSB data. The address may include a line index LI and a tag T associated with data.

At S513, the application processor 110 may determine whether a hit of a main cache memory 113 is generated. For example, when the input address is equal to an address stored at the main cache memory 113, a hit may be generated. Determining a hit may include selecting a line of the main cache memory 113 corresponding to the line index LI of the input address and determining whether a tag T stored at the selected line is equal to a tag of the input address. For example, a line of the main cache memory 113 corresponding to the line index LI may be selected, and the application processor 110 may determine whether a tag of the input address is equal to one of tags stored at the selected line of a plurality of ways WAY_{—}0˜WAY_F. If a hit is generated, the method may proceed to S515. If a hit is not generated, the method may proceed to S531.

If a hit of the main cache memory 113 is generated, that is, if data corresponding to a write-requested address is stored at the main cache memory 113, at S515, the application processor 110 may divide the input data into MSB data and LSB data.

At S517, the application processor 110 may store the MSB data at the main cache memory 113. In one example embodiment, as described with reference to FIGS. 6 and 7A to 7C, if the MSB data stored at the main cache memory 113 is equal to the input MSB data, the operation S517 may be skipped. If the MSB data stored at the main cache memory 113 is not equal to the input MSB data, the application processor 110 may perform an update operation.

At S519, the application processor 110 may determine whether a hit of the sub-cache memory 115 is generated. For example, if LSB data corresponding to the input address is stored at the sub-cache memory 115, a hit may be generated. Determining a hit may include selecting a line of the sub-cache memory 115 corresponding to the LSB index line LBLI of the input address and determining whether a LSB tag LBT stored at the selected corresponds to a tag of the input address. For example, as described with reference to FIGS. 3A and 3B, an address (e.g., line index LI and tag T) of the main cache memory 113 where MSB data is stored may be converted into an address (LSB line index LBLI and LSB tag LBT) managed in the sub-cache memory 115. The converted LSB line index LBLI may be selected, and the application processor 110 may determine whether the LSB tag LBT converted is stored at a sub line of the sub-cache memory 115. If a hit of the sub-cache memory 115 is generated, the method may proceed to S529. If a hit of the sub-cache memory 115 is not generated, the method may proceed to S521.

If a hit of the main cache memory 113 is generated and a hit of the sub-cache memory 115 is not generated, that is, if LSB data corresponding to the input address is not stored at the sub-cache memory 115, at S521, the application processor 110 may determine whether the sub-cache memory 115 includes an invalid sub line. The invalid sub line may include a sub line where LSB data is not stored or a sub line where invalid LSB data is stored. If the sub-cache memory 115 includes an invalid sub line, the method may proceed to S529. If the sub-cache memory 115 does not include an invalid sub line, the method may proceed to S523.

If a hit of the main cache memory 113 is generated, a hit of the sub-cache memory 115 is not generated, and the sub-cache memory 115 does not include an invalid sub line, at S523, the application processor 110 may select victim data in the sub-cache memory 115. For example, the application processor 110 may select data, to be written back or flushed into the main cache memory 113, from LSB data stored at the sub-cache memory 115. For example, the application processor 110 may select earliest accessed LSB data from LSB data stored at the sub-cache memory 115 to be written back or flushed into the main cache memory 113.

At S527, the application processor 110 may write back the selected victim data into the main cache memory 113. Afterwards, at S529, LSB data may be stored at the sub-cache memory 115.

If a hit of the main cache memory 113 is generated, a hit of the sub-cache memory 115 is not generated, and the sub-cache memory 115 includes an invalid sub line, at S529, LSB data may be stored at an invalid sub line of the sub-cache memory 115.

If a hit of the main cache memory 113 is generated and a hit of the sub-cache memory 115 is generated, at S529, the application processor 110 may store LSB data at the sub-cache memory 115. In one example embodiment, as described with reference to FIGS. 6 and 7A to 7C, if LSB data stored at the sub-cache memory 115 is equal to the input LSB data, S529 may be skipped. If LSB data stored at the sub-cache memory 115 is not equal to the input LSB data, an update operation may be performed.

At S513, if a hit of the main cache memory 113 is not generated, the process proceeds to S531, as shown in FIG. 10B. At, S531, the application processor 110 may determine whether the main cache memory 113 includes an invalid line. The invalid line may include a line where data is not stored or a line where invalid data is stored. If the main cache memory 113 includes an invalid line, the application processor 110 may store MSB data at an invalid line of the main cache memory 113 (S533). Afterwards, at S534, the process may revert back to S521-S520, as shown in FIG. 10A for storing LSB data at the sub-cache memory 115.

If a hit of the main cache memory 113 is not generated and the main cache memory 113 does not include an invalid line, at S535, the application processor 110 may store victim data at the main cache memory 113. At S537, the application processor 110 may read selected victim data from the main cache memory 113.

At S539, the application processor 110 may determine whether a hit of the sub-cache memory 115 is generated. For example, the application processor 110 may determine whether LSB data of the read victim data is stored at the sub-cache memory 115.

If LSB data of the read victim data is not stored at the sub-cache memory 115, at S549, the application processor 110 may write back read victim data may into a lower cache memory or a main memory 120. Afterwards, the process may revert back to S533.

If LSB data of the read victim data is stored at the sub-cache memory 115, at S541, the application processor 110 may read LSB data from the sub-cache memory 115. At S543, the application processor 110 may combine MSB data read from the main cache memory 113 and LSB data read from the sub-cache memory 115. At S545, the application processor 110 may write the combined data back into a lower cache memory or the main memory 120. At S547, the application processor 110 may store the input LSB data and MSB data at the sub-cache memory 115 and main cache memory 113, respectively.

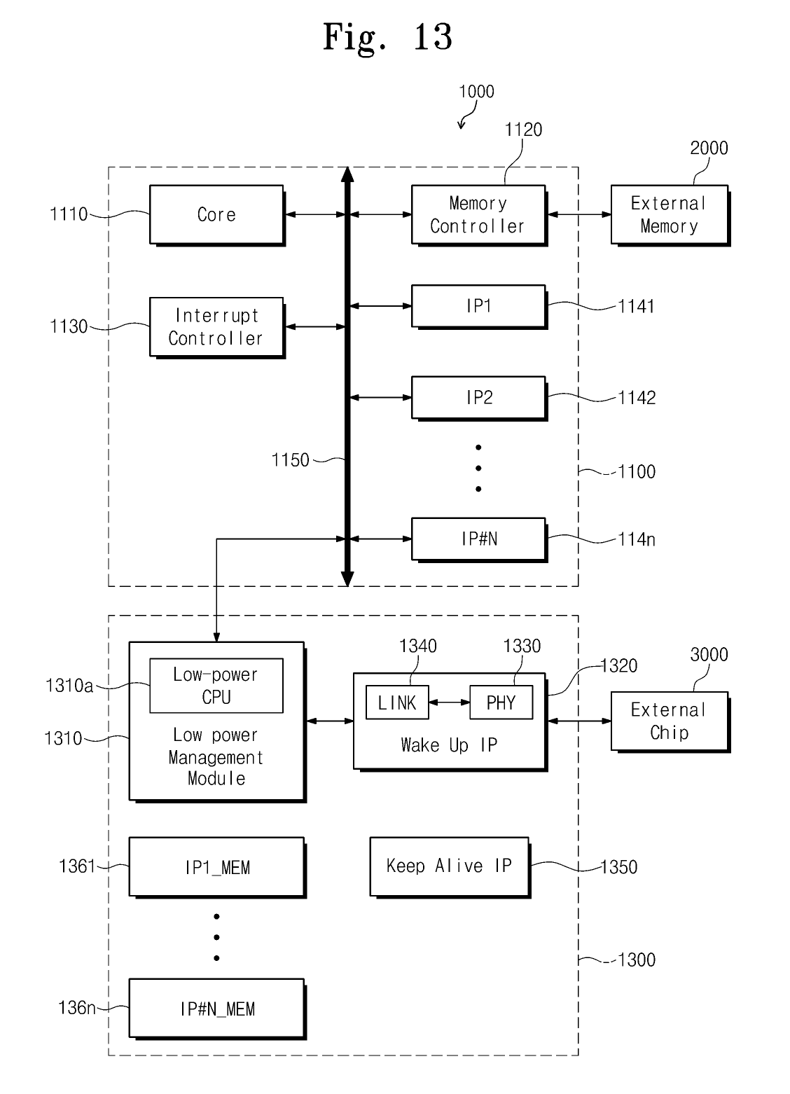

FIG. 100 is a flow chart schematically illustrating an embodiment where data is read from a main cache memory 113 and a sub-cache memory 115 of FIGS, according to an example embodiment. 1, 3A and 3B. Referring to FIGS. 1, 3A, 3B, and 100, at S610, the application processor 110 may receive a read request and an address. The address may include a line index LI and a tag T of a main cache memory 113.

At S620, the application processor 110 determines whether a hit of the main cache memory 113 is generated. In one example embodiment, the application processor 110 may determine whether a tag equal to the input tag T is stored at lines of ways WAY_{—}0˜WAY_F of the main cache memory 113 corresponding to the input line index LI. In one example embodiment, the application processor 110 may determine whether read-requested data is stored at the main cache memory 113. If so, the method may proceed to S630. If not, the method may proceed to S680.

If, at S620, the application processor 110 determines that the requested data is stored at the main cache memory 113, at S630, the application processor 110 may read the requested data stored at the main cache memory 113. At S640, the application processor 110 may determine whether a hit of the sub-cache memory 115 is generated. For example, the application processor 110 may determine whether LSB data of the requested data is stored at the sub-cache memory 115. If, at S640, the application processor 110 determines that the LSB data of the requested data is stored at the sub-cache memory 115, the method may proceed to S650. If, at S640, the application processor 110 determines that LSB data of the requested data is not stored at the sub-cache memory 115, the method may proceed to S670.

If LSB data of the requested data is stored at the sub-cache memory 115, at S650, the application processor 110 may read LSB data from the sub-cache memory 115. At S660, the application processor 110 may combine MSB data read from the main cache memory 113 and LSB data read from the sub-cache memory 115. At S670, the application processor 110 may output the combined data, as read data.

If, at S640, the application processor 110 determines that LSB data of the requested data is not stored at the sub-cache memory 115, the application processor 110 may store LSB data and MSB data of the requested data at the main cache memory 113. Thus, at S670, the application processor 110 may output LSB data and MSB data read from the main cache memory 113, as read data.

If, at S620, the application processor 110 determines that LSB data of the requested data is not stored at the main cache memory 113, the application processor 110 may request a fetch of the requested data. At S680, the application processor 110 may fetch the requested data from a lower cache memory or a main memory 120. Afterwards, at S690, as described with reference to FIG. 10A, the application processor 110 may store the fetched data at the main cache memory 113 and the sub-cache memory 115. At S670, the application processor 110 may output data stored at the main cache memory 113 and the sub-cache memory 115, as read data.

FIG. 11A is a graph schematically illustrating access times of cache memories according to an example embodiment of the inventive concepts. In FIG. 11A, an access time when data is read from a main cache memory 113 and an access time when data is read from the main cache memory 113 and a sub-cache memory 115 are illustrated.

Referring to FIGS. 1, 3A, and 11A, when data is read from a main cache memory 113, a data access operation may be performed after tag decoding of the main cache memory 113 is performed.

When data is read from the main cache memory 113 and a sub-cache memory 115, a data access operation may be performed after tag decoding of the main cache memory 113 is performed. While a data access operation on the main cache memory 113 is executed, tag decoding of the sub-cache memory 115 may be performed. In one example embodiment, the main cache memory 113 may be configured to store information on all addresses of a main memory 120 using a line index LI and a tag T. The sub-cache memory 115 may be configured to store information on all addresses of a main memory 120 using a LSB line index LBLI and an LSB tag LBT. Since a storage capacity of the main memory 120 is larger than that of the main cache memory 113, a length of the tag T may be longer than that of the LSB tag LBT. That is, a decoding time of the LSB tag LBT may be shorter than that of the tag T. For example, decoding of the LSB tag LBT of the sub-cache memory 115 may be completed before a data access operation of the main cache memory 113 is ended.

After tag decoding of the sub-cache memory 115 is performed, a data access operation of the sub-cache memory 115 may be performed. A size of LSB data stored at the sub-cache memory 115 may be smaller than that of LSB data and MSB data stored at the main cache memory 113. That is, a data access time of the sub-cache memory 115 may be shorter than that of the main cache memory 113. For example, a data access operation of the sub-cache memory 115 may be completed at a point of time similar to a point of time when a data access operation of the main cache memory 113 is completed.

An access time when data is read from the main cache memory 113 and the sub-cache memory 115 may not be longer than that when data is read from the main cache memory 113. Likewise, an access time when data is stored at the main cache memory 113 and the sub-cache memory 115 may not be longer than that when data is read from the main cache memory 113.

FIG. 11B is a graph schematically illustrating access times of cache memories according to an example embodiment of the inventive concepts. In FIG. 11B, an access time when data is read from a main cache memory 113 and an access time when data is read from the main cache memory 113 and a sub-cache memory 115 are illustrated.

Referring to FIGS. 1, 3A, and 11B, when data is read from a main cache memory 113, tag decoding and data accessing on the main cache memory 113 may be performed in parallel.

When data is read from the main cache memory 113 and the sub-cache memory 115, tag decoding and data accessing on the main cache memory 113 may be performed in parallel with tag decoding and data accessing on the sub-cache memory 115.

As described with reference to FIGS. 11A, a tag decoding time and a data access time of the sub-cache memory 115 may be shorter than a tag decoding time and a data access time of the main cache memory 113. Thus, an access time when data is read from the main cache memory 113 and the sub-cache memory 115 may not be longer than the access time when data is read from the main cache memory 113. Likewise, an access time when data is stored at the main cache memory 113 and the sub-cache memory 115 may not be longer than that when data is read from the main cache memory 113.

FIG. 12A is a diagram for describing read operations of a main cache memory 113 and a sub-cache memory 115. Referring to FIGS. 1, 3A, and 12A, a main cache memory 113 may include an address buffer AB, a tag array TA, a row decoder RD1, a read and write circuit RW1, an intermediate circuit S1, a plurality of data arrays DA1 to DAF, a row decoder RD2, a column decoder CD1, a plurality of read and write circuits RW2_{—}1 to RW2_F, and an input/output circuit S2.

The address buffer AB may be configured to receive and store an address from an external device. For example, the address buffer AB may be configured to receive and store a line index LI and a tag T from the application processor 110. The address buffer AB may transfer the line index LI to the row decoders RD1 and RD2 and an LSB address buffer LBAB of the sub-cache memory 115 and the tag T to the intermediate circuit S1.

The tag array TA may be configured to store tags T₁ to T_{F} associated with data stored at the main cache memory 113. The tags T₁ to T_{F} may be managed together with valid data V₁ to V_{F} including information on validity of associated data. The tags T₁ to T_{F} and the valid data V₁ to V_{F} may be stored in a matrix form. For example, rows of the tags T₁ to T_{F} and the valid data V₁ to V_{F} may correspond to lines (i.e., line indexes LI) of the main cache memory 113. Columns of the tags T₁ to T_{F} and the valid data V₁ to V_{F} may correspond to ways WAY_{—}0˜WAY_F of the main cache memory 113.

At a read operation, the row decoder RD1 may be configured to select rows of the tag array TA in response to the line index LI from the address buffer AB. At a read operation, the read and write circuit RW1 may be configured to read tags T₁ to T_{F} and valid data V₁ to V_{F} in a selected row. The tags T₁ to T_{F} and the valid data V₁ to V_{F} may be transferred to the intermediate circuit S1.

At a read operation, the intermediate circuit S1 may determine whether a hit of the main cache memory 113 is generated. The intermediate circuit S1 may compare the tags T₁ to T_{F} from the tag array TA with the tag T from the address buffer AB. A hit may be generated when the tags T₁ to T_{F} from the tag array TA include a tag equal to the tag T from the address buffer AB and data associated with the tag is valid. An encoder ENC1 of the intermediate circuit S1 may transfer a column address of the tag determined to be hit to the column decoder CD1, and may provide the LSB address buffer LBAB with way information WI indicating whether the tag determined to be hit exists at any way of the main cache memory 113. The way information WI may be a column address of the tag array TA where the tag determined to be hit is stored.

The data arrays DA1 to DAF may be configured to store data. The data arrays DA1 to DAF may correspond to the ways WAY_{—}0˜WAY_F of the main cache memory 113, respectively. Each of the data arrays DA1 to DAF may store data in a matrix form based on rows and columns. Rows of the data arrays DA1 to DAF may correspond to lines of the main cache memory 113, respectively. A row of each of the data arrays DA1 to DAF may correspond to a line of the main cache memory 113.

The row decoder RD2 may be configured to select rows of the data arrays DA1 to DAF based on the line index LI from the address buffer AB. The column decoder CD1 may be configured to select a data array corresponding to column information transferred from the encoder ENC1. For example, when the encoder ENC1 outputs information indicating that a hit is generated at an i^{th} column, the column decoder CD1 may select an i^{th} data array of the data arrays DA1 to DAF.

At a read operation, the read and write circuits RW2_{—}1 to RW2_F may read data from lines of the read and write circuits RW2_{—}1 to RW2_F selected by the row decoder RD2. For example, there may be selected data, corresponding to a line of a data array selected by the column decoder CD1, from among data stored at lines selected by the row decoder RD2.

At a read operation, the input/output circuit S2 may receive data from the read and write circuits RW2_{—}1 to RW2_F. For example, the input/output circuit S2 may receive data of a line selected by the row decoder RD2 and the column decoder CD1. The input/output circuit S2 may output MSB data of the input data to the data buffer DB and LSB data thereof to an input/output circuit S4 of the sub-cache memory 115.

The sub-cache memory 115 may include an LSB address buffer LBAB, an LSB tag array LBTA, a row decoder RD3, a read and write circuit RW3, an intermediate circuit, a plurality of LSB data arrays LBDA1 to LBDAi, a row decoder RD4, a column decoder CD2, a plurality of read and write circuits RW4_{—}1 to RW4_i, and an input/output circuit S4.

The LSB address buffer LBAB may receive the line index LI from the address buffer AB and the way information WI from the intermediate circuit S1. The LSB address buffer LBAB may combine the line index LI and the way information WI to form an address. The LSB address buffer LBAB may divide the address thus generated into an LSB line index LBLI and an LSB tag LBT. That is, the LSB address buffer LBAB may convert an address of the main cache memory 113 into an address of the sub-cache memory 115. The LSB line index LBLI may be transferred to the row decoders RD3 and RD4, and the LSB tag LBT may be transferred to the intermediate circuit S3.

The LSB tag array LBTA may be configured to store tags LBT1 to LBT7 associated with data stored at the sub-cache memory 115. The LSB tags LBT1 to LBT7 may be managed together with valid data V₁ to V₇ including information on validity of associated data. The LSB tags LBT1 to LBT7 and the valid data V₁ to V₇ may be stored in a matrix form based on rows and columns. For example, rows of the LSB tags LBT1 to LBT7 and the valid data V₁ to V₇ may correspond to lines (i.e., LSB line indexes LBLI) of the sub-cache memory 115. Columns of the LSB tags LBT1 to LBT7 and the valid data V₁ to V₇ may correspond to ways WAY_{—}0 to WAY_{—}7 of the sub-cache memory 115.

At a read operation, the row decoder RD3 may be configured to select rows of the LSB tag array LBTA in response to the LSB line index LBLI from the LSB address buffer LBAB. At a read operation, the read and write circuit RW3 may be configured to read LSB tags LBT1 to LBT7 and valid data V₁ to V₇ in a row selected by the row decoder RD3. The LSB tags LBT1 to LBT7 and the valid data V₁ to V₇ may be transferred to the intermediate circuit S3.

At a read operation, the intermediate circuit S3 may determine whether a hit of the sub-cache memory 115 is generated. The intermediate circuit S3 may compare the LSB tags LBT1 to LBT7 from the LSB tag array LBTA with the LSB tag LBT from the LSB address buffer LBAB. A hit may be generated when the LSB tags LBT1 to LBT7 from the LSB tag array LBTA include a tag equal to the LSB tag LBT from the LSB address buffer LBAB and data associated with the tag is valid. An encoder ENC2 of the intermediate circuit S3 may transfer a column address of the LSB tag determined to be hit to the column decoder CD2.

The LSB data arrays LBDA1 to LBDA7 may be configured to store data. The LSB data arrays LBDA1 to LBDA7 may correspond to the ways WAY_{—}0 to WAY_{—}7 of the sub-cache memory 115, respectively. Each of the LSB data arrays LBDA1 to LBDA7 may store data in a matrix form based on rows and columns. Rows of the data arrays LBDA1 to LBDA7 may correspond to sub-lines of the sub-cache memory 115, respectively. A row of each of the LSB data arrays LBDA1 to LBDA7 may correspond to a sub-line of the sub-cache memory 115.

The row decoder RD4 may be configured to select rows of the LSB data arrays LBDA1 to LBDA7 based on the LSB line index LBLI from the LSB address buffer LBAB. The column decoder CD2 may be configured to select a data array corresponding to column information transferred from the encoder ENC2. For example, when the encoder ENC2 outputs information indicating that a hit is generated at an i^{th} column, the column decoder CD2 may select an i^{th} data array of the data arrays DA1 to DA7.

At a read operation, the read and write circuits RW4_{—}1 to RW4_F may read data from sub-lines of the LSB data arrays LBDA1 to LBDA7 selected by the row decoder RD4. For example, there may be selected data, corresponding to a sub-line of an LSB data array selected by the column decoder CD2, from among data stored at sub-lines selected by the row decoder RD4.

At a read operation, the input/output circuit S4 may receive data from the read and write circuits RW4_{—}1 to RW4_F. For example, the input/output circuit S4 may receive data of a sub-line selected by the row decoder RD4 and the column decoder CD2. The input/output circuit S4 may output one of LSB data from the input/output circuit S2 in the main cache memory 113 and LSB data from the read and write circuits RW4_{—}1 to RW4_F to the data buffer DB. For example, in the event that a hit of the sub-cache memory 115 is generated at the intermediate circuit S3, the input/output circuit S4 may output the LSB data from the read and write circuits RW4_{—}1 to RW4_F to the data buffer DB. On the other hand, in the event that a hit of the sub-cache memory 115 is not generated at the intermediate circuit S3, the input/output circuit S4 may output the LSB data from the input/output circuit S2 in the main cache memory 113.

In summary, in a tag array TA and circuits (e.g., the row decoder RD1, the read and write circuit RW1, and the intermediate circuit S1) associated with the tag array TA, whether a hit of the main cache memory 113 is generated may be determined. If a hit of the main cache memory 113 is generated, data may be read from the data arrays DA1 to DAF and circuits (e.g., the row decoder RD2, the column decoder CD1, and the read and write circuits RW2_{—}1 to RW2_F) associated with the data arrays DA1 to DAF. MSB data of the read data may be output to the data buffer DB.

In a LSB tag array LBTA and circuits (e.g., the row decoder RD3, the read and write circuit RW3, and the intermediate circuit S3) associated with the LSB tag array LBTA, whether a hit of the sub-cache memory 115 is generated may be determined. If a hit of the sub-cache memory 115 is generated, LSB data may be read from the LSB data arrays LBDA1 to LBDA7 and circuits (e.g., the row decoder RD4, the column decoder CD2, and the read and write circuits RW4_{—}1 to RW4_F) associated with the LSB data arrays LBDA1 to LBDA7. One of LSB data from the main cache memory 113 and LSB data from the sub-cache memory 115 may be output to the data buffer DB, based on whether a hit of the sub-cache memory 115 is generated.

FIG. 12B is a diagram for describing read operations of a main cache memory 113 and a sub-cache memory 115, according to an example embodiment. For ease of description, a description which is duplicated with that of FIG. 12A may be skipped.

Referring to FIGS. 1, 3A, and 12B, at a write operation, a row decoder RD1 may be configured to select rows of a tag array TA in response to a line index LI received from an address buffer AB.

At a write operation, an intermediate circuit S1 may determine whether a hit of a main cache memory 113 is generated. The intermediate circuit S1 may compare tags T₁ to T_{F} from the tag array TA with a tag T from the address buffer AB. A hit may be generated when the tags T₁ to T_{F} from the tag array TA include a tag equal to the tag T from the address buffer AB and data associated with the tag is valid. An encoder ENC1 of the intermediate circuit S1 may transfer a column address of the tag determined to be hit. If a hit of the main cache memory 113 is not generated, the intermediate circuit S1 may select a column address corresponding to a column where an invalid tag is stored or a column where a tag is not stored, from a selected row. Selection of the column address may be performed by a valid block selector IBS1. One of a column address determined to be hit by the encoder ENC1 and an address selected by the valid block selector IBS1 may be transferred to the column decoder CD1, and may be transferred to an LSB address buffer LBAB as way information WI.

The row decoder RD2 may be configured to select rows of a plurality of data arrays DA1 to DAF based on a line index LI from the address buffer AB. The column decoder CD1 may be configured to select a data array corresponding to column information transferred from the intermediate circuit S1.

At a write operation, an input/output circuit S2 may transfer MSB data of data stored at a data buffer DB to a plurality of read and write circuits RW2_{—}1 to RW2_F. For example, the input/output circuit S2 may provide MSB data to a read and write circuit selected by the column decoder CD1. The read and write circuits RW2_{—}1 to RW2_F may store MSB data from the input/output circuit S2 at a line selected by the row decoder RD2 and the column decoder CD1.

At a write operation, a row decoder RD3 may be configured to select rows of an LSB tag array LBTA in response to an LSB line index LBLI from an LSB address buffer LBAB. At a write operation, a read and write circuit RW3 may be configured to read LSB tags LBT1 to LBT7 and valid data V₁ to V₇ in a row selected by the row decoder RD3.

At a write operation, an intermediate circuit S3 may determine whether a hit of the sub-cache memory 115 is generated. The intermediate circuit S3 may compare LSB tags LBT1 to LBT7 from an LSB tag array LBTA with an LSB tag LBT from the LSB address buffer LBAB.

An encoder ENC2 of the intermediate circuit S3 may output a column address of an LSB tag determined to be hit. When a hit of the sub-cache memory 115 is not generated, the intermediate circuit S3 may select a column address corresponding to a column where an invalid LSB tag is stored or a column where an LSB tag is not stored, from a selected row. Selection of the column address may be performed by a valid block selector IBS2. One of a column address determined to be hit by the encoder ENC2 and an address selected by the valid block selector IBS2 may be transferred to the column decoder CD2.

A row decoder RD4 may be configured to select rows of a plurality of LSB data arrays LBDA1 to LBDA7 based on an LSB line index LBLI from the LSB address buffer LB. A column decoder CD2 may be configured to select an LSB data array corresponding to column information transferred from the intermediate circuit S3.

At a write operation, an input/output circuit S4 may provide a plurality of read and write circuits RW4_{—}1 to RW4_F with LSB data of data stored at the data buffer DB. For example, the input/output circuit S4 may transfer LSB data to a read and write circuit selected by the column decoder CD2. The read and write circuits RW4_{—}1 to RW4_F may store LSB data input from the input/output circuit S4 at a line selected by the row decoder RD2 and the column decoder CD1.

In summary, if a hit is generated at a write operation, the main cache memory 113 or the sub-cache memory 115 may be updated. If a hit is not generated, data may be stored at an invalid line of the main cache memory 113 or the sub-cache memory 115.

FIG. 12C is a diagram for describing an operation where LSB data is written back to a main cache memory 113 from a sub-cache memory 115, according to an example embodiment. For ease of description, a description which is duplicated with that of FIG. 12A or FIG. 12B may be skipped.

Referring to FIGS. 1, 3A, and 12C, a row decoder RD3 may be configured to select rows of an LSB tag array LBTA in response to an LSB line index LBLI received from an LSB address buffer LBAB. A read and write circuit RW3 may be configured to LSB tags LBT1 to LBT7 and valid data V₁ to V₇ in a row selected by the row decoder RD3.

An intermediate circuit S3 may select a tag to be written back of tags stored at a sub-cache memory 115. For example, the intermediate circuit S3 may select an earliest access tag as a tag to be written. Selection of the tag to be written back may be performed by a victim data selector VS. An encoder ENC2 may transfer a column address of a tag selected by the victim data selector VS to a column decoder CD2. Under the control of the intermediate circuit S3, valid data associated with the selected tag may be updated through an input/output circuit S3 to be invalidated.

A row decoder RD4 may be configured to select rows of a plurality of LSB data arrays LBDA1 to LBDA7 based on an LSB line index LBLI from the LSB address buffer LBAB. A column decoder CD2 may be configured to select an LSB data array corresponding to column information transferred from the intermediate circuit S3.

An input/output circuit S4 may output LSB data of a line selected by the row decoder RD4 and the column decoder CD2 to a data buffer DB.

An input/output circuit S2 may LSB data stored at the data buffer DB at an LSB area of a line selected by the row decoder RD2 and the column decoder CD1.

In FIGS. 12A to 12C, an example where internal components of the intermediate circuits S1 and S3 and the input/output circuits S2 and S4 are different from each other, are illustrated. However, the inventive concept is not limited thereto. The intermediate circuits S1 and S3 and the input/output circuits S2 and S4 may be configured to support all functions described with reference to FIGS. 12A to 12C and to selectively perform the functions.

Embodiments of the inventive concepts may be performed according to operations described with reference to FIGS. 12A to 12C. For example, when data is stored at the main cache memory 113 and the sub-cache memory 115, data may be read according to an operation which is described with reference to FIG. 12A, and the read data may be compared with data to be stored. As described with reference to FIG. 12B, selective updating on the main cache memory 113 and the sub-cache memory 115 may be performed according to the comparison result.

In the main cache memory 113 and the sub-cache memory 115, a fetch operation may be performed after writing-back to the main cache memory 113. Data stored at the main cache memory 113 and the sub-cache memory 115 may be read according to an operation described with reference to FIG. 12A, and may be written back to the main cache memory 113. Afterwards, an update operation may be performed such that valid data associated with the data written back is invalidated. The fetched data may be stored at a line, which stores invalid data, according to an operation described with reference to FIG. 12B.

In the main cache memory 113 and the sub-cache memory 115, a data storing operation may be performed after writing-back (or, flushing) of LSB data. The writing-back (or, flushing) may be performed according to an operation described with reference to FIG. 12B. Afterwards, a data storing operation may be performed according to an operation described with reference to FIG. 12B.

FIG. 13 is a block diagram schematically illustrating an application processor 1000 and an external memory 2000 and an external chip 3000 communicating with the application processor 1000, according to an example embodiment. Referring to FIG. 13, an application processor 1000 may comprise a power-off domain block 1100 and a power-on domain block 1300.

The power-off domain block 1100 may be a block which is powered down to realize a low power of the application processor 1000. The power-on domain block 1300 may be a block which is powered on to perform a part of a function of the power-off domain block 1100 when the power-off domain block 1100 is powered down.

The power-off domain block 1100 may include a core 1110, an interrupt controller 1130, a memory controller 1120, a plurality of intellectual properties (IPs) 1141 to 114n, and a system bus 1150. The plurality of intellectual properties are specific layout designs of hardware circuits such as integrated circuits.

The core 1110 may control the memory controller 1120 to access an external memory 2000. The memory controller 1120 may send data stored at the external memory 2000 to the system bus 1150 in response to a control of the core 1110.

When an interrupt (i.e., a specific event) is generated from each of the intellectual properties (IPs) 1141 to 114n, the interrupt controller 1130 may inform the core 1110 of the interrupt. The intellectual properties (IPs) 1141 to 114n may perform concrete operations according to a function of the application processor 1000. The intellectual properties (IPs) 1141 to 114n may access inherent internal memories 1361 to 136n, respectively. The power-on domain block 1300 may include the inherent internal memories 1361 to 136n of the intellectual properties (IPs) 1141 to 114n.

The power-on domain block 1300 may include a lower-power management module 1310, a wakeup IP 1320, a keep alive IP 1330, and the internal memories 1361 to 136n of the intellectual properties (IPs) 1141 to 114n.

The lower-power management module 1310 may decide a wake-up of the power-off domain block 1100 according to data transferred from the wake-up IP 1320. A power of the power-off domain block 1100 may be powered off during a standby state where the power-off domain block 1100 waits for an external input. The wake-up may mean such an operation that a power is again applied when external data is provided to the application processor 1000. That is, the wake-up may be an operation of allowing the application processor 1000 to go to an operating state (i.e., a power-on state) again.

The wake-up IP 1320 may include a PHY 1330 and a LINK 1340. The wake-up IP 1320 may interface between the low power management module 1310 and an external chip 3000. The PHY 1330 may actually exchange data with the external chip 3000, and the LINK 1340 may transmit and receive data actually exchanged through the PHY 1330 to and from the low power management module 1310 according to a predetermined protocol.

The keep alive IP 1350 may determine a wake-up operation of the wake-up IP 1320 to activate or inactivate a power of the power-off domain block 1100.

The low power management module 1310 may receive data from at least one of the intellectual properties 1141 to 114n. In the event that data not processed is only transferred, the low power management module 1310 may store the input data at an internal memory of a corresponding IP instead of the core 1110.

Internal memories 1361 to 136n of the intellectual properties 1141 to 114n may be access by corresponding intellectual properties at a power-on mode and by the low power management module 1310 at a power-off mode.

The power-off domain block 1100 may include a main cache memory 113 and a sub-cache memory 115 according to an embodiment of the inventive concept. For example, the main cache memory 113 and the sub-cache memory 115 may be included in the core 1110 or provided to communicate with the core 1110 through the system bus 1150. For example, the main cache memory 113 and the sub-cache memory 115 may be included in the power-on domain block 1300.

While the inventive concepts has been described with reference to one or more example embodiments, it will be apparent to those skilled in the art that various changes and modifications may be made without departing from the spirit and scope of the present subject matter. Therefore, it should be understood that the above example embodiments are non-limiting.

What is claimed:

1. A cache memory system, comprising:
a main cache memory including a nonvolatile random access memory, the main cache memory configured to exchange data with an external device and store the exchanged data, each exchanged data including less significant bit (LSB) data and more significant bit (MSB) data; and
a sub-cache memory including a random access memory, the sub-cache memory configured to store LSB data of at least a portion of data stored in the main cache memory,
wherein the main cache memory and the sub-cache memory are formed of a single-level cache memory.

2. The cache memory system of claim 1, wherein each of the main cache memory and the sub-cache memory includes a plurality of lines, an invalid line being one of the plurality of lines that does not store data, and
when an invalid line exists at the sub-cache memory and new data is received from the external device,
the main cache memory is further configured to store MSB data of the received data at a MSB area of a selected invalid line of the main cache memory, and
the sub-cache memory is further configured to store LSB data of the received data at the invalid line of the sub-cache memory.

3. The cache memory system of claim 1, wherein each of the main cache memory and the sub-cache memory includes a plurality of lines, an invalid line being one of the plurality of lines that does not store data, and
when an invalid line does not exist at the sub-cache memory and new data is received from the external device,
the sub-cache memory is further configured to,
write LSB data of data stored at a selected line of the sub-cache memory, to an LSB area of a corresponding line of the main cache memory,
invalidate the written LSB data at the selected line of the sub-cache memory, and
store LSB data of the received data at the selected line of the sub-cache memory, and
the main cache memory is further configured to store MSB data of the received data at an MSB area of a selected invalid line of the main cache memory.

4. The cache memory system of claim 1, wherein if a difference exists between LSB data of an update data received from the external device and LSB data of the data stored at the sub-cache memory,
the sub-cache memory is further configured to update the LSB data of the data stored at the sub-cache memory with the LSB data of the update data.

5. The cache memory system of claim 1, wherein if a difference exists between LSB data of an update data received from the external device and LSB data of the data stored at the main cache memory,
the main memory is further configured to update the LSB data of the data stored at the main cache memory with the LSB data of the update data.

6. The cache memory system of claim 1, wherein when MSB data of a selected data is stored at the main cache memory, LSB data of the selected data is stored at the sub-cache memory, and the selected data is to be read by the external device,
the main cache memory is further configured to provide the MSB data stored at the main cache memory to the external device, and
the sub-cache memory is further configured to provide the LSB data stored at the sub-cache memory to the external device.

7. The cache memory system of claim 1, wherein when MSB data of a selected data is stored at the main cache memory, LSB data of the selected data is stored at the main cache memory, and the selected data is to be read by the external device,
the main cache memory is further configured to provide the MSB data and the LSB data stored at the main cache memory to the external device.

8. The cache memory system of claim 1, wherein the main cache memory is a magnetic random access memory.

9. The cache memory system of claim 1, wherein the sub-cache memory is a static random access memory.

10. The cache memory system of claim 1, wherein the sub-cache memory consumes less power for a write operation compared to a write operation carried out by the main cache memory.

11. The cache memory system of claim 1, wherein the sub-cache memory operates based on the main cache memory.

12. The cache memory of claim 1, wherein the main cache memory comprises:
an address buffer configured to store a line index and a tag associated with data received from the external device;
a plurality of data arrays, each data array including a plurality of lines, each line being configured to store LSB data and MSB data associated with one of the received data;
a tag array configured to store tags associated with data stored at the plurality of data arrays;
a first intermediate circuit configured to,
access the tag array, and
determine whether a first hit is generated, based on the line index and the tag stored at the address buffer; and
a first input/output circuit configured to access the plurality of data arrays according to the line index and the determination of the generated first hit by the first intermediate circuit.

13. The cache memory of claim 12, wherein the sub-cache memory comprises:
an LSB address buffer configured to,
receive the line index from the address buffer,
receive information on a location of the plurality of data arrays for which the first intermediate circuit has determined that the first hit is generated, and
output an LSB line index and an LSB tag based on the input line index and the received information;
a plurality of LSB data arrays, each LSB data array including a plurality of sub-lines, each sub-line being configured to store LSB data;
an LSB tag array configured to store LSB tags associated with LSB data stored at the plurality of LSB data arrays;
a second intermediate circuit configured to,
access the LSB tag array and to determine whether a second hit is generated, based on the LSB line index, and
the LSB tag output from the LSB address buffer; and
a second input/output circuit configured to access the plurality of LSB data arrays according to the LSB line index and the determination of the generated second hit by the second intermediate circuit.

14. A data managing method of an application processor which includes a main cache memory and a sub-cache memory, the method comprising:
fetching MSB data and LSB data; and
managing the fetched MSB data using an MSB area of the main cache memory and the fetched LSB data using at least one of the sub-cache memory and an LSB area of the main cache memory,
wherein the MSB data and the LSB data form a data line being a data transfer unit.

15. The data managing method of claim 14, wherein the managing comprises:
receiving the LSB data and the MSB data; and
storing the received MSB data at the MSB area of the main cache memory and the received LSB data at an invalid line of the sub-cache memory when an invalid line exists at the sub-cache memory, the invalid line being a line that does not store data.

16. The data managing method of claim 15, wherein when an invalid line does not exist at the sub-cache memory, the method further comprises:
writing to the main cache memory, at least one additional LSB data previously stored at a given location in the sub-cache memory, and
storing the received LSB data at the given location of the sub-cache memory.

17. The data managing method of claim 14, wherein the managing comprises:
receiving updated data including updated LSB data and updated MSB data;
reading data corresponding to the updated LSB data and the updated MSB data from at least one the main cache memory and the sub-cache memory;
comparing the read data and the updated LSB data and the updated MSB data;
updating LSB data of the read data stored at the sub-cache memory when (1) the comparison result indicates that the LSB data of the read data and updated LSB data are different from each other and (2) the LSB data of the read data is stored at the sub-cache memory;
updating LSB data of the read data stored at the LSB area of the main cache memory when (1) the comparison result indicates that the LSB data of the read data and the updated LSB data are different from each other and (2) the LSB data of the read data is stored at the LSB area of the main cache memory; and
updating MSB data of the read data stored at the MSB area of the main cache memory when the comparison result indicates that the MSB data of the read data and the updated MSB data are different from each other.

18. The data managing method of claim 14, wherein the managing comprises:
receiving a data request;
selecting data corresponding to the data request from at least one of the main cache memory and the sub-cache memory; and
reading the selected data.

19. The data managing method of claim 14, wherein the managing comprises:
decoding a tag of the main cache memory;
accessing data of the main cache memory, based on the decoded tag of the main cache memory;
decoding a tag of the sub-cache memory while data of the main cache memory is accessed; and
accessing data of the sub-cache memory, based on the decoded tag of the sub-cache memory.

20. The data managing method of claim 14, wherein the managing comprises:
decoding a tag of the main cache memory;
accessing data of the main cache memory while the tag of the main cache memory is decoded;
decoding a tag of the sub-cache memory while the tag of the main cache memory is decoded; and
accessing data of the sub-cache memory while the tag of the main cache memory is decoded.

21. An application processor configured to:
exchange data with an external device;
store a first portion of the exchanged data in a main cache memory of the application processor, the main cache memory including a nonvolatile random access memory;
store a second portion of the exchanged data in a sub-cache memory of the application processor, the sub-cache memory including a random access memory.

22. The application processor of claim 21, wherein the application processor is configured to exchange the data by at least one of,
receiving the data from an external device to be stored in at least one of the main cache memory and the sub-cache memory of the application processor, and
providing the stored data to be read by the external device.

23. The application processor of claim 21, wherein the first portion of the exchanged data includes more significant bit (MSB) data of the exchanged data, and
the second portion of the exchanged data includes less significant bit (LSB) data of the exchanged data.

24. The application processor of claim 23, wherein upon receiving data from the external device, the application processor is configured to,
store the MSB data of the received data in the main cache memory.

25. The application processor of claim 23, wherein upon receiving data from the external device, the application processor is configured to,
determine whether an empty location for storing the LSB data of the received data exists within the sub-cache memory, and
store the LSB data of the received data in the determined empty location of the sub-cache memory.

26. The application processor of claim 25, wherein the application processor is further configured to,
upon determining that no empty location for storing the LSB data of the received data exists within the sub-cache memory, write LSB data of at least one additional data already stored in a given location of the sub-cache memory into an empty location of the main cache memory corresponding to a location of the main memory in which the MSB data of the at least one additional data is stored, and
store the LSB data of the received data in the given location of the sub-cache memory.

27. The application processor of claim 21, wherein upon receiving updated data, the application processor is further configured to,
determine whether LSB data of the updated data is different from the LSB data of the data already stored in one of the main cache memory and the sub-cache memory, and
replace the LSB data of the data already stored with the LSB data of the updated data, upon determining that the LSB data of the updated data is different from the LSB data of the data already stored.
